(19) United States
(12) Patent Application Publication
(10) Pub. No.: US 2026/0189007 A1
(43) Pub. Date: Jul. 2, 2026

(54) METHODS AND APPARATUS TO DETERMINE SOLAR IRRADIANCE

(71) Applicant: SunSight Energy Intelligence, LLC, Chicago, IL (US)

(72) Inventors: Chase Monroe Albright, Richmond, TX (US); Christian Signorelli, Lockport, IL (US)

(21) Appl. No.: 19/427,371

(22) Filed: Dec. 19, 2025

Related U.S. Application Data
(60) Provisional application No. 63/741,286, filed on Jan. 2, 2025.

(51) Int. Cl. H02J 3/00; G06T 7/11; G06T 7/246; G06T 7/50; G06T 7/73; H02J 3/38; H02J 101/24; H02J 103/30

(52) U.S. Cl. CPC H02J 3/004; G06T 7/11; G06T 7/251; G06T 7/50; G06T 7/75; H02J 3/381; G06T 2207/10016; G06T 2207/10024; G06T 2207/20084; H02J 2101/24; H02J 2103/30

(57) ABSTRACT

Systems, apparatus, articles of manufacture, and methods are disclosed to predict solar irradiance. The prediction of solar irradiance includes to record data collected by the sensor, the data corresponding to a future weather condition; package the data for transmission to a server, wherein to package the data further includes to: record data for the sensor at a sampling interval; and tag the data with a label corresponding to collection of the data by the sensor; and transmit the data to the server, the server to determine a solar irradiance model by performing image processing of an image received from a collection device; determining a characteristic of a cloud in the image; and determining a solar irradiance model based on the determined characteristic.

### RELATED APPLICATION

This patent claims the benefit of U.S. Provisional Patent Application No. 63/741,286, which was filed on Jan. 2, 2025. U.S. Provisional Patent Application No. 63/741,286 is hereby incorporated herein by reference in its entirety. Priority to U.S. Provisional Patent Application No. 63/741,286 is hereby claimed.

### FIELD OF THE DISCLOSURE

This disclosure relates generally to solar irradiance and, more particularly, to methods and apparatus to determine solar irradiance.

### BACKGROUND

In recent years, the forecasting of solar irradiance is unreliable as solar irradiance is determined from intermittent readings due to fluctuations of solar power (e.g., due to movement of clouds, weather fluctuations, etc.). Due to the intermittent nature of solar irradiance, grid operators must maintain and regulate reserve capacity to ensure grid stability.

As the usage of photovoltaic power (e.g., power produced via conversion of sunlight into electricity using semiconducting materials) rises, determination and prediction of solar irradiance ensures grid stability despite fluctuations in solar power.

### BRIEF DESCRIPTION OF THE DRAWINGS

FIG. 1 is a block diagram of an example environment in which an example solar tracker operates to track solar irradiance.

FIG. 2 is a block diagram of an example implementation of the solar tracker of FIG. 1.

FIG. 3 is a block diagram of an example implementation of controller circuitry of the solar tracker of FIG. 2.

FIG. 4 is a block diagram of an example implementation of server circuitry of FIG. 1.

FIG. 5 is an example diagram of the solar tracker of FIG. 1.

FIG. 6 is a flowchart representative of example machine readable instructions and/or example operations that may be executed, instantiated, and/or performed by example programmable circuitry to implement the controller circuitry of FIG. 3.

FIG. 7 is a flowchart representative of example machine readable instructions and/or example operations that may be executed, instantiated, and/or performed by example programmable circuitry to implement the controller circuitry of FIG. 3.

FIG. 8 is a flowchart representative of example machine readable instructions and/or example operations that may be executed, instantiated, and/or performed by example programmable circuitry to implement the server circuitry of FIG. 4.

FIG. 9 is a flowchart representative of example machine readable instructions and/or example operations that may be executed, instantiated, and/or performed by example programmable circuitry to implement the server circuitry of FIG. 4.

FIG. 10 is a flowchart representative of example machine readable instructions and/or example operations that may be executed, instantiated, and/or performed by example programmable circuitry to implement the server circuitry of FIG. 4.

FIG. 11 is a flowchart representative of example machine readable instructions and/or example operations that may be executed, instantiated, and/or performed by example programmable circuitry to implement the server circuitry of FIG. 4.

FIG. 12 is a flowchart representative of example machine readable instructions and/or example operations that may be executed, instantiated, and/or performed by example programmable circuitry to implement the server circuitry of FIG. 4.

FIG. 13 is a flowchart representative of example machine readable instructions and/or example operations that may be executed, instantiated, and/or performed by example programmable circuitry to implement the server circuitry of FIG. 4.

FIG. 14 is a block diagram of an example processing platform including programmable circuitry structured to execute, instantiate, and/or perform the example machine readable instructions and/or perform the example operations of FIGS. 6-7 to implement the controller circuitry of FIG. 3.

FIG. 15 is a block diagram of an example implementation of the programmable circuitry of FIG. 11.

FIG. 16 is a block diagram of another example implementation of the programmable circuitry of FIG. 11.

FIG. 17 is a block diagram of an example software/firmware/instructions distribution platform (e.g., one or more servers) to distribute software, instructions, and/or firmware (e.g., corresponding to the example machine readable instructions of FIGS. 6-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 18 is a block diagram of an example processing platform including programmable circuitry structured to execute, instantiate, and/or perform the example machine readable instructions and/or perform the example operations of FIGS. 8-13 to implement the server circuitry of FIG. 4.

FIG. 19 is a block diagram of an example implementation of the programmable circuitry of FIG. 15.

FIG. 20 is a block diagram of another example implementation of the programmable circuitry of FIG. 15.

FIG. 21 is a block diagram of an example software/firmware/instructions distribution platform (e.g., one or more servers) to distribute software, instructions, and/or firmware (e.g., corresponding to the example machine readable instructions of FIGS. 8-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Determination and prediction of solar irradiance can lead to inaccurate results due to fluctuations from weather conditions (e.g., changing weather, cloud movement, unpredicted weather phenomena, etc.). As used herein, solar irradiance refers to the output of solar power per unit area. In particular, as reliance on solar energy (e.g., photovoltaic power) increases, the prediction and determination of a future solar irradiance event ensures reserves of photovoltaic power are available.

Power markets are extremely volatile, and grid reliability is a major concern across the world as aging infrastructure and surging demand impact grids worldwide. For example, in Texas alone, consumers have experienced extreme price swings and grid instability due to solar energy volatility. In particular, due to industry realizations such as the “Duck Curve,” which demonstrates that the time of day for peak electricity demand does not align with the time of day of peak available solar energy, a need for prediction of solar irradiance events is necessary for efficient solar determination and usage.

Currently, satellite technology and remote sensing captures data at a scale that is too vast for the resolution needed to determine precise solar irradiance. Therefore, there is a need for a device that is scalable to the desired environment to determine solar irradiance, and that captures data at a resolution required for precise solar irradiance determinations. Further, due to the volatility of solar irradiance, there is a need for a device to predict solar irradiance forecasts based on the current conditions.

In particular, prediction of solar irradiance can be used by solar farms to modulate the frequency of solar power. Solar farms disperse power collected from solar panels to a grid at a grid frequency. If solar power is disrupted, this can lead to grid instability as solar farms may not have power stored to ensure consistent power dispersion. Solar farms can use predictions of solar irradiance to determine when solar power will be less available (e.g., future cloud cover, etc.), and can meter dispersal of power prior (e.g., change the grid frequency) to the solar irradiance event. Therefore, when solar power is less available, solar farms can still provide consistent power using solar irradiance predictions.

Further, hedging and market considerations can be made based on the predictions of solar irradiance. As solar irradiance is a volatile market, prediction of solar power and the availability in various regions allows for hedging to reduce unexpected large energy expenditures.

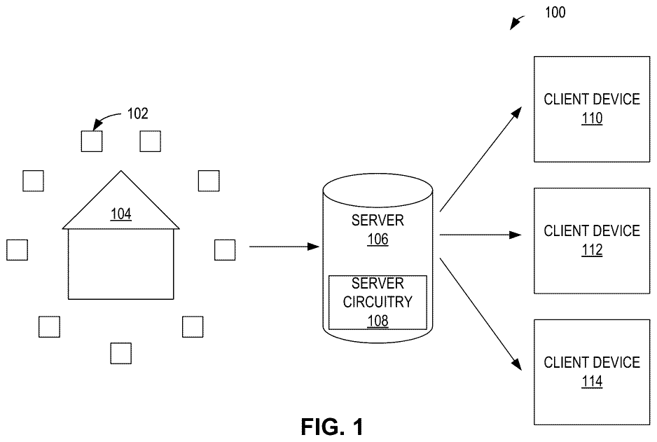

FIG. 1 is a block diagram of an example environment 100 in which an example solar tracker 102 operates to record data corresponding to solar irradiance around an example geographic location 104. The recorded data is sent to an example server 106. The server 106 processes the data for transmittal to example client devices 110, 112, 114.

The solar trackers 102 determine and record solar irradiance events using sensors. The sensors of the solar trackers 102 can include a pyranometer, a camera, a hygrometer, a barometer, a thermometer, an anemometer, and a solar panel. However, the solar trackers 102 can include other sensors and/or any other subset or combination of the sensors (e.g., any subset or combination of the pyranometer, the camera, the hygrometer, the barometer, the thermometer, the anemometer, the solar panel, etc.). Further, while the illustrated example of FIG. 1 shows nine solar trackers 102, there can be any number of solar trackers 102 per a given unit area (e.g., a constant number of trackers per unit of area, a variable number of trackers per unit of area, etc.).

The solar trackers 102 record solar irradiance events and/or data around the geographic location 104. The geographic location 104 can be any area for which a determination and/or a prediction of a solar irradiance event is desired (e.g., a residential home, a commercial building, a field, a body of water, a rural area, an urban area, a fence surrounding an area, on top of a building in an urban area, in a neighborhood, etc.). In some examples, the geographic location 104 is identified based on geographic coordinates, georeferenced locations, and/or another location reference system. The solar trackers 102 record local weather and environmental data of the geographic location 104. Accordingly, due to the sensors, the solar trackers 102 record hyper-local data before solar panels in the same area experience a power production disruption. Therefore, the solar trackers 102 record data indicative of a future solar irradiance event. The recorded data can be utilized to predict the future solar irradiance event via machine learning and other data processing. Further, the recorded data of the solar trackers 102 can be utilized to determine a solar irradiance event (e.g., a current solar irradiance event) via processing of current recorded data.

In some examples, the solar trackers 102 are arranged in a perimeter around the geographic location 104 to collect data (e.g., to collect data corresponding to wind speed and direction in the varying locations of the perimeter around the geographic location 104, etc.). Further, in other examples, the solar trackers 102 are arranged in a grid to collect data corresponding to solar irradiance events. In still other examples, the solar trackers 102 are arranged in any configuration around the geographic location 104. Therefore, the solar trackers 102 can determine weather data (e.g., hyper-local weather data) relevant to the geographic location 104 to determine solar irradiance events for the area.

The server 106 receives collected data from the solar trackers 102 corresponding to the geographic location 104. In some examples, the server 106 receives the collected data from the solar trackers 102 via a cellular network connection. In other examples, the server 106 receives the collected data over an internet connection or other transmission medium. The server 106, through server circuitry 108, processes the received data to determine current solar irradiance conditions and to predict a current solar irradiance event. In some examples, the server circuitry 108 instantiates an algorithm to determine the predicted solar irradiance event (e.g., the future solar irradiance event) based on the collected data (e.g., based on collected images, weather data, determination of cloud classification and movement, etc.). In other examples, the server circuitry 108 implements a machine learning model to predict solar irradiance. In these examples, the server circuitry 108 uses satellite imagery to detect a number of solar panels per unit area. Then, based on the number of solar panels and collected weather data (e.g., time series sensor data such as irradiance, barometric pressure, temperature, solar angle, etc.), the model determines a predicted solar irradiance event.

Lastly, the server 106 transmits the predicted solar irradiance event to the client devices 110, 112, 114. The server 106 can transmit the predicted solar irradiance event to the client devices 110, 112, 114 through a cellular network connection, an internet network connection, or other transmission medium. The client devices 110, 112, 114 can be portable user devices, desktop computers, and/or any other electronic device. The predictions by the server 106 can be viewed via an application and/or an online website accessible via the client device 110, 112, 114. In some examples, the client device 110, 112, 114 display via a user interface the outputs of the server 106 (e.g., the outputs of the machine learning model, etc.).

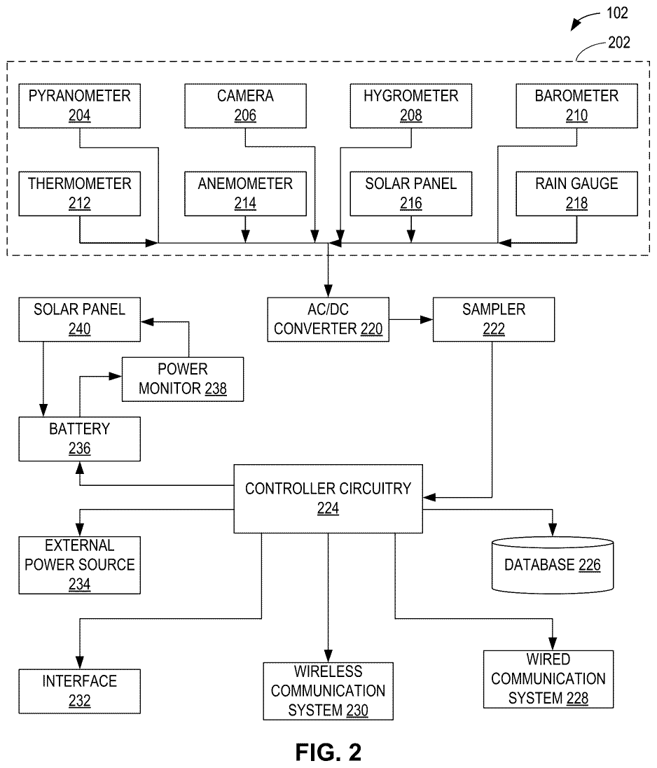

FIG. 2 is an example implementation of the solar tracker 102 to track weather conditions for the geographic location 104 of FIG. 1. In the illustrated example of FIG. 2, the solar tracker 102 includes an example sensor panel 202. The sensor panel 202 includes an example pyranometer 204, an example camera 206, an example hygrometer 208, an example barometer 210, an example thermometer 212, an example anemometer 214, an example solar panel 216, and an example rain gauge 218. In the illustrated example of FIG. 2, there are eight sensors. In other examples, the solar tracker 102 includes more sensors, less sensors, and/or any other combination of sensors.

The pyranometer 204 of the sensor panel 202 measures solar irradiance on a planar surface (e.g., corresponding to an area of the geographic location 104). In some examples, the pyranometer 204 measures solar radiation flux density (e.g., W/m²) and considers the curve of the Earth in collecting measurements.

The sensor panel 202 further includes the camera 206. In some examples, the camera 206 is an imaging device (e.g., an all sky imager) that captures panoramic images of the sky (e.g., the hemisphere) and obtains details of clouds and cloud cover at the geographic location 104. The camera 206 captures images of the sky at regular intervals (e.g., every minute, every thirty seconds, every millisecond, every thirty minutes, etc.). Based on the images collected by the camera 206, algorithms stored in the camera 206 can determine cloud cover and other weather events related to clouds based on the images.

The sensor panel 202 further includes the hygrometer 208. The hygrometer 208 measures the humidity of the air at the geographic location 104. The hygrometer 208 measures the amount of water vapor in the air and reports the humidity level as a percentage. In some examples, the hygrometer 208 takes several measurements over time (e.g., a humidity level measurement per second, etc.).

The sensor panel 202 further includes the barometer 210. The barometer 210 measures atmospheric pressure (e.g., air pressure) at the geographic location 104. In some examples, the barometer 210 takes several measurements over time (e.g., one atmospheric pressure measurement per second, etc.).

The sensor panel 202 further includes the thermometer 212. The thermometer 212 measures temperature for the geographic location 104. In some instances, the thermometer 212 takes several measurements over time (e.g., one temperature measurement per second, etc.).

The sensor panel 202 further includes the anemometer 214. The anemometer 214 measures wind speed and direction at the geographic location. In some examples, the anemometer 214 measures velocity of the wind in a plane perpendicular to the axis of rotation of a component of the anemometer 214. In some examples, a measurement of wind speed by the anemometer 214 is based on the unit of time (e.g., one measurement per 30 seconds, one measurement per 1 minute, etc.). In these examples, the measurement is based on the rotation of the anemometer 214 per unit of time. In some examples, the measurement of wind speed is performed by the anemometer 214 and a measurement of wind direction is performed by a wind vane connected to the anemometer 214.

The sensor panel 202 further includes the solar panel 216. The solar panel 216 converts solar energy into electricity using photovoltaic cells. The amount of electricity generated by the solar panel 216 is collected to determine a measurement of the solar energy at the geographic location 104.

The sensor panel 202 further includes the rain gauge 218. The rain gauge 218 records a volume of rainfall over time at the geographic location 104. In some examples, the rain gauge 218 measures an amount of rainfall based on a height measurement (e.g., inches, centimeters, etc.) of rain sensed by the rain gauge 218.

After the sensor panel 202 records data, the output of the sensor panel 202 is passed to an example sensor interface 220. The sensor interface 220 facilitates data acquisition, processing, and communication between the controller circuitry 224 and the sensor panel 202. In some examples, the sensor interface 220 includes an alternating current (AC)/direct current (DC) converter that converts the analog signals of the sensor panel to digital form for further processing.

In some examples, the sensor interface 220 is instantiated by an inter-integrated circuit (I²C), a serial peripheral interface (SPI), a camera serial interface (CSI), and/or a universal asynchronous receiver-transmitter (UART).

I²C is a two-wire, synchronous communication protocol that is ideal for use in low-speed interfaces. I²C allows multiple sensors of the sensor panel 202 (e.g., barometers, thermometers, hygrometers, etc.) to share a single bus. Therefore, I²C simplifies wiring and reduces complexity. In particular, I²C is used for capturing periodic, low-bandwidth environmental data essential for hyper-local solar irradiance predictions.

SPI supports sensors requiring fast, low-latency communication (e.g., anemometers, AC/DC converter data, etc.). In some examples, an AC/DC converter converts analog signals from sensors on the sensor panel 202 (e.g., thermistors, rain gauges, etc.) into digital data for processing by the controller circuitry 224. SPI ensures minimal delay in transmission of the high-frequency data.

CSI is a specialized connection for high-speed imaging devices. CSI is designed for cameras that capture wide-lens information (e.g., an all sky imager). CSI ensures high-resolution image capture with minimal processing by the controller circuitry 224.

In examples where the sensor data is simple to transmit, UART is used. UART connects the sensor interface 220 to the server 106. UART supports remote system monitoring and data transfer to the server 106.

By facilitating data collection and processing, the sensor interface 220 enables robust and efficient data collection from multiple environmental sensors and imaging devices. High-speed interfaces, like CSI and SPI, ensure seamless handling of large data volumes from camera and AC/DC converters. Conversely, low-speed interfaces, like I²C and UART manage periodic environmental data and communication modules. The combination of the high-speed and low-speed interfaces enhances the scalability, reliability, and accuracy of the solar irradiance prediction system to enable operation in diverse deployment scenarios.

An example sampler 222 samples the digital data to generate data sets. In some examples, the sampler 222 samples at a sampling rate greater than 100 Hz (e.g., greater than 100 samples per second). However, the sampler 222 can sample at any rate. Further, the sampler 222 can sample in regular, periodic, and/or aperiodic intervals. Accordingly, the output of the sampler 222 is a data set corresponding to the data collected from the geographic location 104 grouped based on the sampling interval.

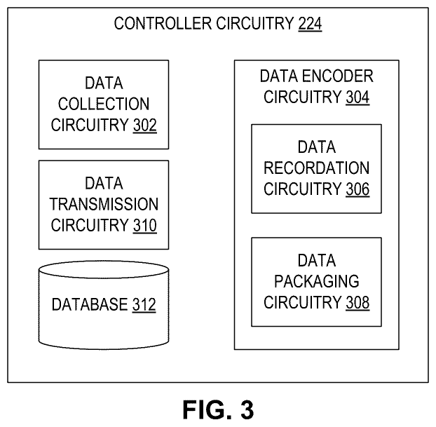

The sampler 222 provides the sampled data to example controller circuitry 224. The controller circuitry 224 is described in greater detail in connection to FIG. 3. The controller circuitry 224 outputs the data to various locations after organization and packetization of the data.

In some examples, the controller circuitry 224 will output the data to an example database 226. In these examples, the database 226 stores the data for use in further solar irradiance predictions. In some examples, the database 226 stores the data until the controller circuitry 224 transmits the data stored in the database 226 to the server 106 for further processing. In some examples, the database 226 stores data temporarily if the data cannot be transmitted immediately to the server 106 (e.g., network connectivity is disabled, insufficient power for transmission, etc.).

In some examples, the controller circuitry 224 outputs the data to the server 106 in FIG. 1 via an example wireless communication system 230 and/or an example wired communication system 228. The wireless communication system 230 can be instantiated by a cellular transmission unit 229 on the solar tracker 102 to send the data to the server 106. The cellular transmission unit 229 provides an interface (e.g., a physical interface, an electrical interface, etc.) between the controller circuitry 224 and a cellular network for data transmission and reception. The cellular transmission unit 229 can translate data signals between the cellular network and the controller circuitry 224, regulate voltage and current supplied to the cellular network from the controller circuitry 224 to ensure stable operation even when power supply fluctuations occur, and/or provide stable communication between the solar tracker 102 and the cellular network. In some examples, the cellular transmission unit 229 connects each solar tracker 102 to the cellular network to enable transmission of the local data to a centralized server. In these examples, the cellular transmission unit 229 includes a cellular communication module configured to connect to cellular networks for wireless data exchange. The cellular communication module can support various cellular communication standards (e.g., 4G LTE, 3G, GSM, 5G, etc.). In some examples, the cellular transmission unit 229 ensures continuous data flow, even in geographically isolated locations where Wi-Fi is unavailable, because the cellular transmission unit 229 provides reliable communication to support near real-time forecasts and enhanced grid stability. Further, the cellular transmission unit 229 allows scalability of the deployment of solar trackers 102 as the solar trackers 102 can be deployed without dependence on local network infrastructure. In some examples, the cellular transmission unit 229 includes antenna connectors or integrated antennas to enhance signal reception and transmission.

However, in other examples, the wireless communication system 230 wirelessly transmits the data to the server 106 via other connections (e.g., analog transmission, digital transmission, etc.). Wireless transmission of information (e.g., Wi-Fi, LoRa, Zigbee, etc.) allows implementation of the solar trackers 102 in locations where wiring is impractical. For example, an external weather station captures additional environmental data (e.g., wind direction, radiation, etc.) and transmits it wirelessly to the central system. Wireless protocols reduce wiring complexity and enable scaling the system across multiple geographic locations to support a comprehensive solar irradiance prediction network.

The solar tracker 102 further includes an example interface 232. The interface 232 can display the data from the controller circuitry 224. Further, the interface 232 can display information relating to a condition of the solar tracker 102 (e.g., damage to the solar tracker, health of a battery of the solar tracker, etc.). In some examples, the solar tracker 102 does not include the interface 232, and, instead, transmits data and/or information regarding a condition of the solar tracker 102 to a device of the user (e.g., a cell phone, an application of a user device, a website, etc.) for display.

Further, the solar tracker 102 includes an external power source 234. The external power source 234 can be a wired connection to electricity and/or a battery pack to provide power to the solar tracker 102. In some examples, the external power source 234 powers the solar tracker if solar power and/or battery power is insufficient.

Lastly, the solar tracker 102 includes a battery 236, a power monitor 238, and a solar panel 240. In some examples, the solar tracker 102 utilizes electricity generated by the solar panel 240 to power the operations of the solar tracker 102. However, in some conditions there is not enough solar energy to power the solar tracker 102 (e.g., cloud cover, a storm, etc.). Therefore, the solar tracker 102 further includes a power monitor 238 that tracks whether the solar energy output of the solar panel 240 falls below a threshold (e.g., the solar panel is not receiving sufficient sunlight to power the solar tracker 102). If the solar energy output of the solar panel 240 falls below the threshold, the solar tracker 102 utilizes power from the battery 236 to continue operation of the solar tracker 102. In these examples, the power monitor 238 regulates power to the components of the solar tracker 102 to ensure continuous operation. In some examples, general purpose input output pins connect the power monitor 238 to the battery 236. These pins can track battery 236 and solar panel 240 performance, can enable or disable power to the power monitor 238, and optimize energy usage with the solar panel 240 and/or other components of the system. In some examples, the solar panel 240 is connected to a voltage regulator. In these examples, after stepping down (e.g., reducing voltage of) the electricity generated by the solar panel 240, the electricity is used to charge the battery 236.

FIG. 3 is a block diagram of an example implementation of the controller circuitry 224 of FIG. 1 to record data for the determination of a solar irradiance event. The controller circuitry 224 includes example data collection circuitry 302, example data encoder circuitry 304, example data recordation circuitry 306, example data packaging circuitry 308, example data transmission circuitry 310, and an example database 312. The controller circuitry 224 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the controller circuitry 224 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

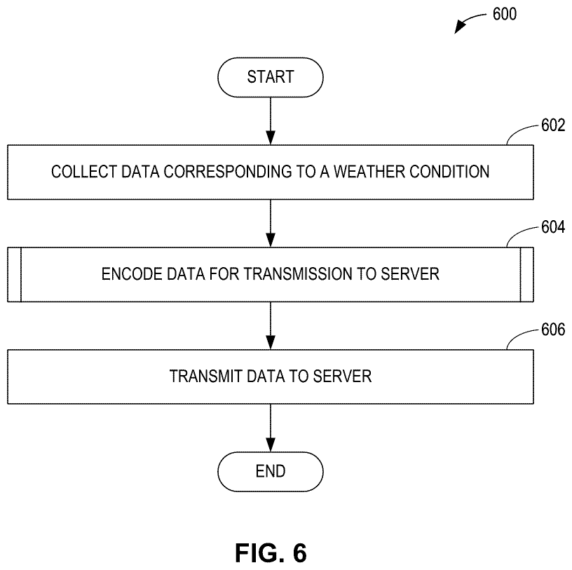

The controller circuitry 224 includes the data collection circuitry 302. The data collection circuitry 302 causes the sensor panel 202 of FIG. 2 to collect data corresponding to the geographic location 104 of FIG. 1. In some examples, the data collection circuitry 302 causes collection of data corresponding to a future weather condition (e.g., collected data is used to predict solar irradiance at a future time). In other examples, the data collection circuitry 302 causes collection of data corresponding to a current weather condition (e.g., collected data is to determine solar irradiance at the time of data collection). In some examples, the data collection circuitry 302 is instantiated by programmable circuitry executing data collection instructions and/or configured to perform operations such as those represented by the flowchart of FIG. 6 (block 602).

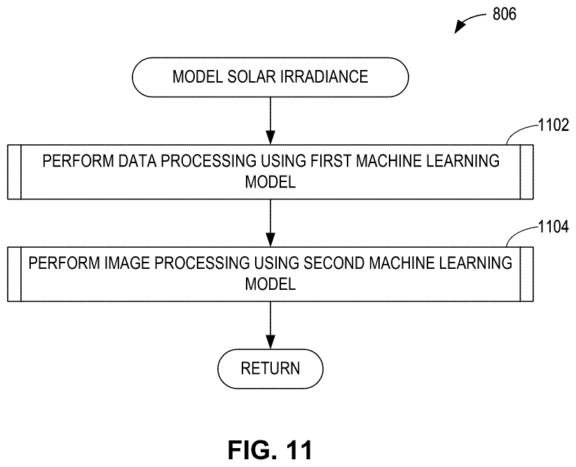

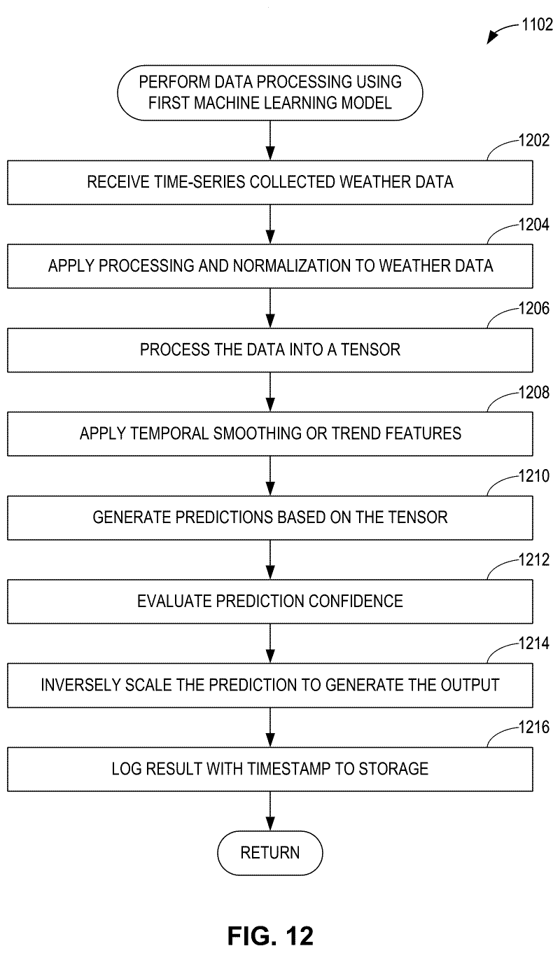

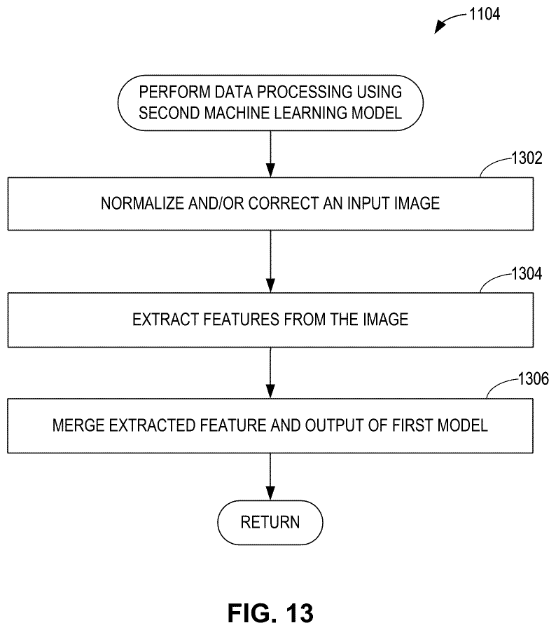

In some examples, the controller circuitry includes means for collecting data corresponding to a weather condition. For example, the means for collecting may be implemented by data collection circuitry 302. In some examples, the data collection circuitry 302 may be instantiated by programmable circuitry such as the example programmable circuitry 1112 of FIG. 11. For instance, the data collection circuitry 302 may be instantiated by the example microprocessor 1200 of FIG. 12 executing machine executable instructions such as those implemented by at least block 602 of FIG. 6. In some examples, the data collection circuitry 302 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data collection circuitry 302 may be instantiated by any other combination of hardware, software, and/or firmware. For example, the data collection circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

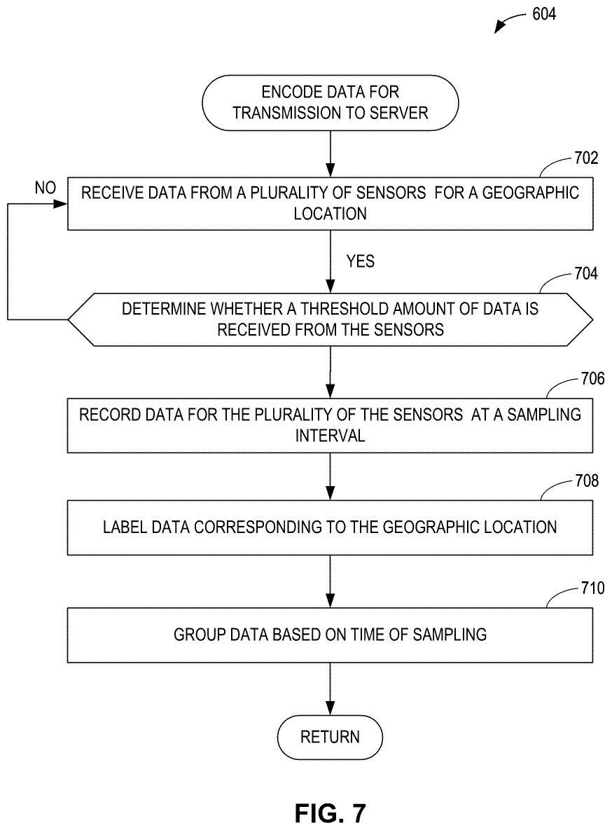

The controller circuitry 224 includes the data encoder circuitry 304. The data encoder circuitry 304 includes example data recordation circuitry 306 and example data packaging circuitry 308. The data encoder circuitry 304 encodes data for transmission to the server 106 of FIG. 1. The data encoder circuitry 304 determines the data collected by the sensors and packages the data for transmission to the server 106 for determination of a solar irradiance model by the server 106 of FIG. 1. In some examples, the data encoder circuitry 304 is instantiated by programmable circuitry executing data encoder instructions and/or configured to perform operations such as those represented by the flowchart of FIG. 6 (block 604) and FIG. 7.

In some examples, the controller circuitry includes means for encoding collected data for transmission to the server. For example, the means for encoding may be implemented by data encoder circuitry 304. In some examples, the data encoder circuitry 304 may be instantiated by programmable circuitry such as the example programmable circuitry 1112 of FIG. 11. For instance, the data encoder circuitry 304 may be instantiated by the example microprocessor 1200 of FIG. 12 executing machine executable instructions such as those implemented by at least block 604 of FIG. 6 and blocks 702-710 of FIG. 7. In some examples, the data encoder circuitry 304 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data encoder circuitry 304 may be instantiated by any other combination of hardware, software, and/or firmware. For example, the data encoder circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The data encoder circuitry 304 includes the data recordation circuitry 306. The data recordation circuitry 306 records data collected by the sensors of the solar tracker 102 of FIG. 1. The data recordation circuitry 306 receives data from a plurality of sensors of a solar tracker for a geographic location (e.g., the solar trackers 102 for the geographic location 104 of FIG. 1). In some examples, the data is received from less sensors than the total number of sensors of the solar tracker 102 (e.g., data will be received from three sensors when there are four sensors onboard the solar tracker 102). Further, the data recordation circuitry 306 determines whether all data is received from the relevant sensors. In some examples, the data recordation circuitry 306 receives all data stored by the solar tracker 102, data corresponding to a time interval, and/or any other denomination of data from the solar tracker 102. The data recordation circuitry 306 records data for the solar tracker at a sampling interval. In some instances, the data recordation circuitry 306 can use the sampler 222 of FIG. 2 to sample the data. The data recordation circuitry 306 can record the data in categories based on a type of sensor that recorded the data (e.g., readings from the pyranometer 204 are grouped together, readings from the thermometer 212 are grouped together, etc.). In some examples, the data recordation circuitry 306 is instantiated by programmable circuitry executing data recordation instructions and/or configured to perform operations such as those represented by the flowchart of FIG. 7 (blocks 702-706).

In some examples, the controller circuitry includes means for recording data collected by the sensors of the solar tracker. For example, the means for recording may be implemented by data recordation circuitry 306. In some examples, the data recordation circuitry 306 may be instantiated by programmable circuitry such as the example programmable circuitry 1112 of FIG. 11. For instance, the data recordation circuitry 306 may be instantiated by the example microprocessor 1200 of FIG. 12 executing machine executable instructions such as those implemented by at least blocks 702-706 of FIG. 7. In some examples, the data recordation circuitry 306 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data recordation circuitry 306 may be instantiated by any other combination of hardware, software, and/or firmware. For example, the data recordation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The data encoder circuitry 304 includes the data packaging circuitry 308. The data packaging circuitry 308 packages the data for transmission to the server 106 of FIG. 1. The data packaging circuitry 308 labels the data from the sensors of the solar tracker 102 based on the geographic location 104. Then, the data packaging circuitry 308 groups the data based on the time of collection (e.g., the time of sampling of data). In some examples, the data packaging circuitry 308 is instantiated by programmable circuitry executing data packaging instructions and/or configured to perform operations such as those represented by the flowchart of FIG. 7 (blocks 708-710).

In some examples, the controller circuitry includes means for packaging the data from the solar tracker for transmission to the server. For example, the means for packaging may be implemented by data packaging circuitry 308. In some examples, the data packaging circuitry 308 may be instantiated by programmable circuitry such as the example programmable circuitry 1112 of FIG. 11. For instance, the data packaging circuitry 308 may be instantiated by the example microprocessor 1200 of FIG. 12 executing machine executable instructions such as those implemented by at least blocks 708-710 of FIG. 7. In some examples, the data packaging circuitry 308 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data packaging circuitry 308 may be instantiated by any other combination of hardware, software, and/or firmware. For example, the data packaging circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The controller circuitry 224 further includes data transmission circuitry 310. The data transmission circuitry 310 transmits the grouped data from the solar tracker 102 to the server 106 of FIG. 1. As described in connection with FIG. 2, the data transmission circuitry 310 can transmit the data via a wireless connection and/or a wired connection. In some examples, the data transmission circuitry 310 transmits the data via a cellular network connection. In some examples, the data transmission circuitry 310 is instantiated by programmable circuitry executing data transmission instructions and/or configured to perform operations such as those represented by the flowchart of FIG. 6 (block 606).

In some examples, the controller circuitry includes means for transmitting the grouped data from the solar tracker to the server. For example, the means for transmitting may be implemented by data transmission circuitry 310. In some examples, the data transmission circuitry 310 may be instantiated by programmable circuitry such as the example programmable circuitry 1112 of FIG. 11. For instance, the data transmission circuitry 310 may be instantiated by the example microprocessor 1200 of FIG. 12 executing machine executable instructions such as those implemented by at least block 606 of FIG. 6. In some examples, the data transmission circuitry 310 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data transmission circuitry 310 may be instantiated by any other combination of hardware, software, and/or firmware. For example, the data transmission circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The controller circuitry 224 further includes a database 312. The database 312 stores collected data from the data collection circuitry 302 and/or encoded data from the data encoder circuitry 304. In some examples, when there is a network outage and/or connectivity issues before transmission of data to the server 106, the database 312 stores collected and/or encoded data temporarily before transmission to the server 106.

While an example implementation of the controller circuitry 224 of FIG. 2 is illustrated in FIG. 3, one or more of the elements, processes, and/or devices illustrated in FIG. 3 may be combined, divided, re-arranged, omitted, eliminated, and/or implemented in any other way. Further, the example data collection circuitry 302, the example data encoder circuitry 304, the example data recordation circuitry 306, the example data packaging circuitry 308, the example data transmission circuitry 310, the example database 312, and/or, more generally, the example controller circuitry 224 of FIG. 3, may be implemented by hardware alone or by hardware in combination with software and/or firmware. Thus, for example, any of the example data collection circuitry 302, the example data encoder circuitry 304, the example data recordation circuitry 306, the example data packaging circuitry 308, the example data transmission circuitry 310, the example database 312, and/or, more generally, the example controller circuitry 224, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controller circuitry 224 of FIG. 3 may include one or more elements, processes, and/or devices in addition to, or instead of, those illustrated in FIG. 3, and/or may include more than one of any or all of the illustrated elements, processes and devices.

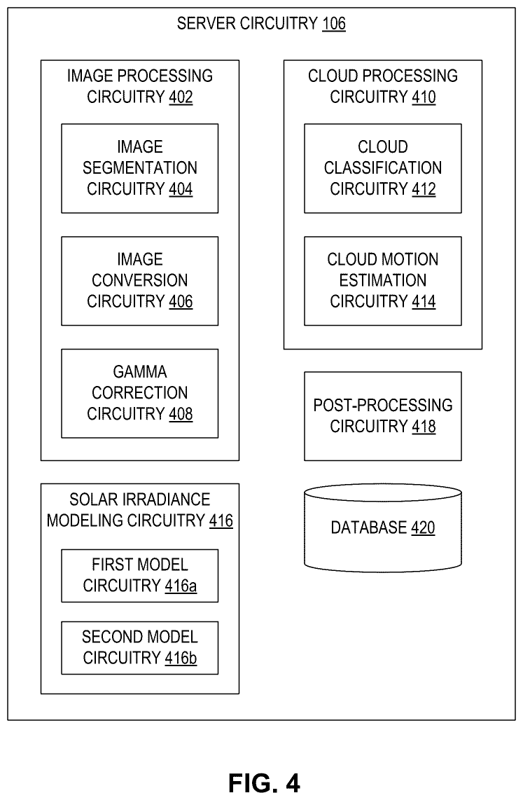

FIG. 4 is a block diagram of an example implementation of the server circuitry 108 of FIG. 1 to predict a solar irradiance event. The server circuitry 108 includes example image processing circuitry 402, example image segmentation circuitry 404, example image conversion circuitry 406, example image correction circuitry 408, example cloud processing circuitry 410, example cloud classification circuitry 412, example cloud motion estimation circuitry 414, example solar irradiance modeling circuitry 416, example post-processing circuitry 418, and an example database 420. The server circuitry 108 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the server circuitry 108 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

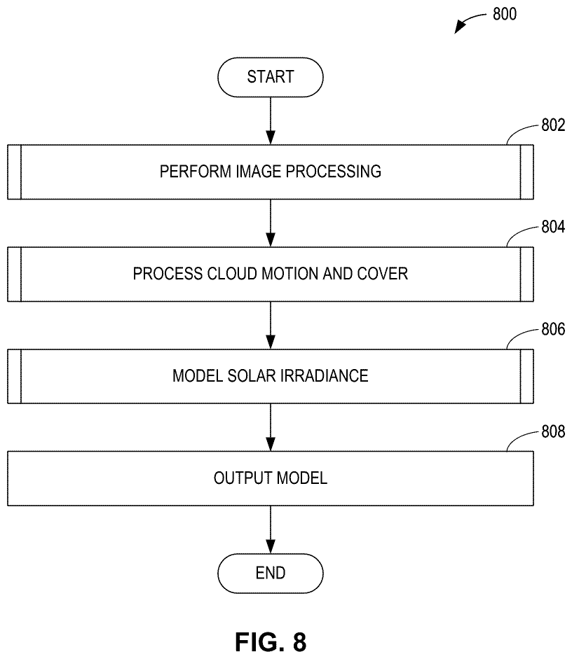

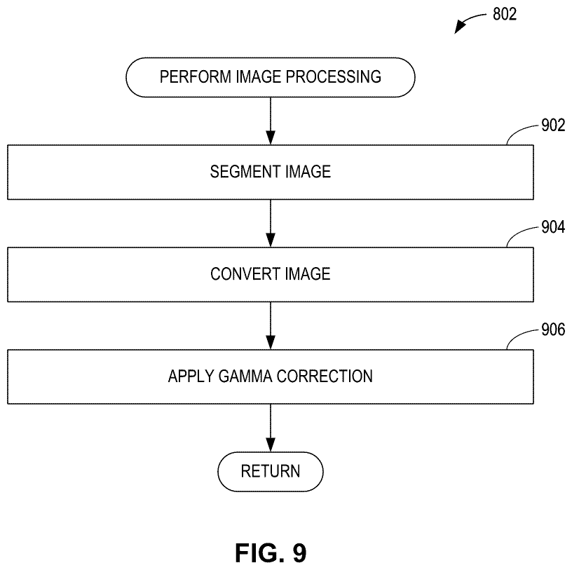

The server circuitry 108 includes the image processing circuitry 402. The image processing circuitry 402 receives the data collected and packaged by the solar tracker 102. The image processing circuitry 402 processes the images taken by the camera 206 with other data received with the image (e.g., other data collected by the sensor panel 202). In some examples, the image processing circuitry 402 processes the images by performing segmentation, conversion, and gamma correction on the collected images. In some examples, to perform the image processing, the image processing circuitry 402 further includes the image segmentation circuitry 404, the image conversion circuitry 406, and the image correction circuitry 408. In some examples, the image processing circuitry 402 is instantiated by programmable circuitry executing image processing instructions and/or configured to perform operations such as those represented by the flowchart of FIG. 8 (block 802) and FIG. 9.

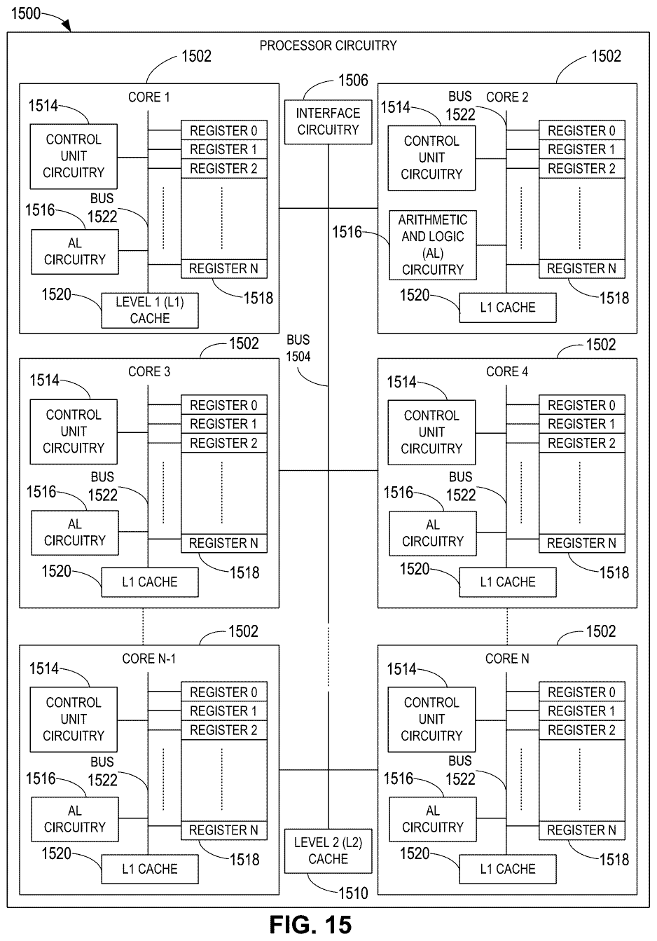

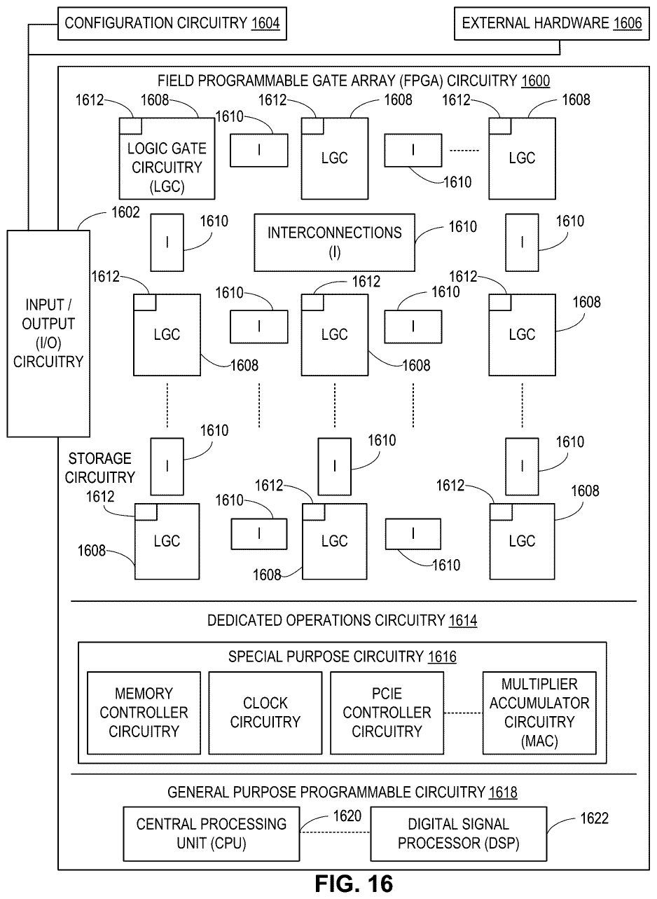

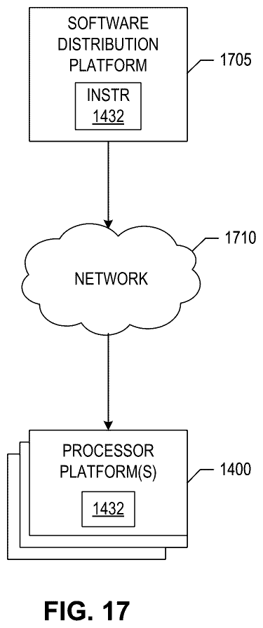

In some examples, the server circuitry includes means for processing images. For example, the means for processing images may be implemented by image processing circuitry 402. In some examples, the image processing circuitry 402 may be instantiated by programmable circuitry such as the example programmable circuitry 1512 of FIG. 15. For instance, the image processing circuitry 402 may be instantiated by the example microprocessor 1600 of FIG. 16 executing machine executable instructions such as those implemented by at least block 802 of FIG. 8 and blocks 902-906 of FIG. 9. In some examples, the image processing circuitry 402 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the image processing circuitry 402 may be instantiated by any other combination of hardware, software, and/or firmware. For example, the image processing circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The image processing circuitry 402 includes the image segmentation circuitry 404. The image segmentation circuitry 404 segments the images captured by the camera 206 into different regions based on proximity to the sun. In some examples, the image segmentation circuitry 404 calculates the Euclidean distance of each pixel of the image from the sun to define areas of interest. The segmentation of the image performed by the image segmentation circuitry 404 allows future processing to focus on regions closer to the sun as clouds in those regions have a greater impact on solar irradiance. In some examples, the image segmentation circuitry 404 divides the images into three zones: Zone 1, Zone 2, and Zone 3 (e.g., a first zone, a second zone, and a third zone, etc.). Zone 1 corresponds to the area closest to the sun and captures details about the clouds that directly affect irradiance. Zone 2 corresponds to an intermediate region with less direct sunlight. Zone 3 corresponds to a region farthest from the sun containing background sky and/or clouds. In some examples, a cosine-weighted sampling method is applied to give more importance to regions near the sun. In some examples, the image segmentation circuitry 404 is instantiated by programmable circuitry executing image segmentation instructions and/or configured to perform operations such as those represented by the flowchart of FIG. 9 (block 902).

In some examples, the server circuitry includes means for segmenting images based on distance from the sun. For example, the means for segmenting images may be implemented by image segmentation circuitry 404. In some examples, the image segmentation circuitry 404 may be instantiated by programmable circuitry such as the example programmable circuitry 1512 of FIG. 15. For instance, the image segmentation circuitry 404 may be instantiated by the example microprocessor 1600 of FIG. 16 executing machine executable instructions such as those implemented by at least block 902 of FIG. 9. In some examples, the image segmentation circuitry 404 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the image segmentation circuitry 404 may be instantiated by any other combination of hardware, software, and/or firmware. For example, the image segmentation circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The image processing circuitry further includes the image conversion circuitry 406. The image conversion circuitry 406 converts images from a red, green, and blue (RGB) color model to a hue, saturation, value (HSV) color model. The HSV color model captures cloud data to be analyzed. In particular, the HSV color model differentiates between clear sky regions and cloud-covered regions using the saturation and value components, and further differentiates between cloud types using the hue component. Further, the image conversion circuitry 406 extracts pixel-level RGB and HSV values that reflect sky and cloud properties. In some examples, the image conversion circuitry 406 preferentially extracts these values from images in Zone 1 (e.g., images captured closest to the sun). In some examples, the image conversion circuitry 406 is instantiated by programmable circuitry executing image conversion instructions and/or configured to perform operations such as those represented by the flowchart of FIG. 9 (block 904).

In some examples, the server circuitry includes means for converting images from RGB to HSV. For example, the means for converting images may be implemented by image conversion circuitry 406. In some examples, the image conversion circuitry 406 may be instantiated by programmable circuitry such as the example programmable circuitry 1512 of FIG. 15. For instance, the image conversion circuitry 406 may be instantiated by the example microprocessor 1600 of FIG. 16 executing machine executable instructions such as those implemented by at least block 904 of FIG. 9. In some examples, image conversion circuitry 406 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the image conversion circuitry 406 may be instantiated by any other combination of hardware, software, and/or firmware. For example, the image conversion circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The image processing circuitry 402 further includes the image correction circuitry 408. The image correction circuitry 408 can apply image conversion techniques to improve visual clarity, optimize data representation, and extract relevant figures from images to determine solar irradiance.

The image correction circuitry 408 can apply gamma correction (e.g., a correction filter) to adjust luminance levels in the converted images. Gamma correction accounts for non-linearities in image data and obtains luminance values to correlate with solar irradiance (e.g., ensures that pixel intensity values accurately represent the real-world brightness of the sky). Gamma correction addresses the non-linear response of camera sensors, which can cause discrepancies between captured pixel values and the actual brightness levels of the sky. Gamma correction modifies the non-linear relationship between pixel intensity values and perceived brightness. Gamma correction can be expressed mathematically as:

$${I}_{corrected} = {I}_{original}^{γ} , \qquad ( 1 )$$

where I_{original} corresponds to the pixel intensity in the original image, γ corresponds to the gamma value used for correction, and I_{corrected} corresponds to the adjusted pixel intensity. A gamma value greater than 1 compresses higher intensity luminance levels and expands lower intensity luminance levels to effectively darken the image. Conversely, a gamma value less than 1 expands higher intensity luminance levels and compresses lower intensity luminance levels to effectively brighten the image.

In some examples, a scaling factor, C, is applied to normalize the pixel values within a specific range, as shown in the equation below:

$${I}_{corrected} = C \cdot {( {I}_{original} )}^{γ} . \qquad ( 2 )$$

Gamma correction addresses the non-linear response of camera sensors as it corrects discrepancies between captured pixel values and the actual brightness levels of the sky. In particular, the correction can enhance contrast in regions closest to the sun to facilitate accurate detection and classification of clouds. Gamma correction ensures that luminance values extracted from the images align with the corresponding solar irradiance measurements.

In some examples, inverse gamma correction is applied to linearize the image for further processing. Inverse gamma correction can be expressed mathematically as:

$${I}_{original} = {I}_{corrected}^{\frac{1}{γ}} . \qquad ( 3 )$$

Further, in some examples, the image correction circuitry 408 applies histogram equalization to redistribute the intensity values of the captured image to enhance global contrast. In this example, the image correction circuitry 408 adjusts the image's dynamic range to allow identification of finer details in underexposed and/or overexposed regions of the sky (e.g., in examples where cloud features are obscured due to uneven lighting conditions). In some examples, gamma correction is applied by the image correction circuitry 408 prior to application of histogram equalization to improve global or local contrast to ensure cloud edges and/or textures are visible.

In some examples, the image correction circuitry 408 applies edge detection to isolate boundaries and edges in an image by identifying regions with significant intensity changes. In this example, the image correction circuitry 408 facilitates the segmentation of cloud regions from the background sky.

In other examples, the image correction circuitry 408 applies spatial filtering (e.g., Gaussian blurring, median filtering, etc.) to smooth images to reduce noise caused by sensor artifacts and/or environmental interference. In these examples, the image correction circuitry 408 improves the accuracy of subsequent processes (e.g., cloud classification, motion estimation, etc.) by smoothing the image.

In other examples, the image correction circuitry 408 applies principal component analysis to condense high-dimensional image data into a smaller set of principal components. In these examples, the image correction circuitry 408 preserves critical features (e.g., cloud opacity relative to the sun (sun occlusion potential), cloud edges and gradients, global luminance distribution, cloud thickness and verticality cues, motion vectors derived from consecutive images, etc.) while discarding redundant or irrelevant information (e.g. pixels near the horizon, lens housing, obstructions, non-sky regions, overexposed regions not near sun disk, etc.). The image correction circuitry 408 determines critical features from non-critical features by using spatial features to determine variance and predictive structures between the features. Further, the image correction circuitry 408 generates an attention map to highlight critical pixels and assign training labels to train a machine learning model which image regions correlate with irradiance changes. In some examples, the image correction circuitry 408 applies gamma correction prior to applying principal component analysis so that the critical features of the clouds are further indicative of real-world conditions.

In other examples, the image correction circuitry 408 applies image binarization to convert greyscale images into binary representations, where pixel values are set to either black or white based on a threshold. In particular, the method can be implemented to identify cloud masks by simplifying the detection of cloud coverage and shape.

In other examples, the image correction circuitry 408 applies Fourier transform-based processing to analyze frequency components of the images and identify periodic patterns (e.g., repetitive cloud structures, etc.). The frequency domain approach of this example can complement spatial-domain methods, like the above, for further detail regarding underlying patterns of cloud motion and texture.

In other examples, the image correction circuitry 408 performs image normalization to ensure that all captured images are scaled to a consistent intensity range and eliminate variability introduced by differing environmental conditions or sensor settings. In some examples, image normalization ensures that captured images are comparable regardless of environmental factors such as time of day of image capture, lighting variations, and/or camera settings. Accordingly, image normalization enhances the consistency of data to enable comparison across time intervals and/or geographic locations. In some examples, the image correction circuitry 408 applies gamma correction and image normalization to enhance the clarity of cloud edges to aid motion detection.

In some examples, the image correction circuitry 408 applies some or all of the above correction techniques to produce the image to be classified for cloud motion and cover. In some examples, the image correction circuitry 408 is instantiated by programmable circuitry executing image correction instructions and/or configured to perform operations such as those represented by the flowchart of FIG. 9 (block 906).

In some examples, the server circuitry includes means for applying image correction techniques to converted images. For example, the means for applying image correction techniques may be implemented by image correction circuitry 408. In some examples, the image correction circuitry 408 may be instantiated by programmable circuitry such as the example programmable circuitry 1512 of FIG. 15. For instance, the image correction circuitry 408 may be instantiated by the example microprocessor 1600 of FIG. 16 executing machine executable instructions such as those implemented by at least block 906 of FIG. 9. In some examples, image correction circuitry 408 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the image correction circuitry 408 may be instantiated by any other combination of hardware, software, and/or firmware. For example, the image correction circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

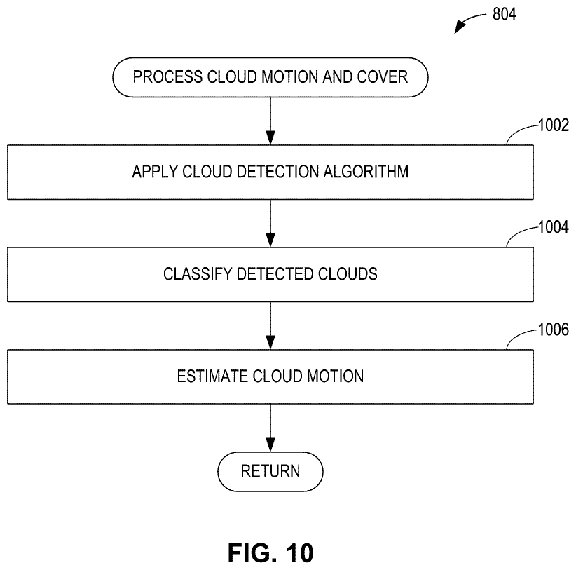

The server circuitry 108 further includes the cloud processing circuitry 410. The cloud processing circuitry 410 processes clouds appearing in images obtained by the camera 206 and processed by the image processing circuitry 402. The cloud processing circuitry 410 detects clouds to identify cloud cover. Then, the cloud processing circuitry 410 classifies the detected clouds to determine their effect on solar irradiance. Further, the cloud processing circuitry 410 determines the motion of clouds and their future movements to determine the effect on solar irradiance. In some examples, cloud cover, type, and movement, processed by the cloud processing circuitry 410, is analyzed so that pixels are sampled to emphasize areas closer to the sun (e.g., the circumsolar region) using a cosine-weighted hemispheric sampling method. Accordingly, in some examples, features (e.g., cloud cover percentage, luminance, radiance values from RGB channels, etc.) are extracted by the cloud processing circuitry 410 from the zones (e.g., Zone 1, Zone 2, Zone 3) of an image. In some examples, the cloud processing circuitry 410 includes example cloud classification circuitry 412 and example cloud motion estimation circuitry 414. In some examples, the cloud processing circuitry 410 is instantiated by programmable circuitry executing cloud processing instructions and/or configured to perform operations such as those represented by the flowchart of FIG. 8 (block 804) and FIG. 10.

In some examples, the server circuitry 108 includes means for processing clouds in an image. For example, the means for processing clouds may be implemented by cloud processing circuitry 410. In some examples, the cloud processing circuitry 410 may be instantiated by programmable circuitry such as the example programmable circuitry 1512 of FIG. 15. For instance, the cloud processing circuitry 410 may be instantiated by the example microprocessor 1600 of FIG. 16 executing machine executable instructions such as those implemented by at least block 804 of FIG. 8 and blocks 1002-1006 of FIG. 10. In some examples, the cloud processing circuitry 410 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the cloud processing circuitry 410 may be instantiated by any other combination of hardware, software, and/or firmware. For example, the cloud processing circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The cloud processing circuitry 410 includes the cloud classification circuitry 412. The cloud classification circuitry 412 detects clouds to identify cloud cover in an image. In some examples, the cloud classification circuitry 412 implements a cloud detection algorithm to detect the clouds. The cloud classification circuitry 412 classifies the detected clouds based on type and/or density (e.g., stratus, cumulus, etc.) and height (e.g., low, medium, high clouds). In some examples, the cloud classification circuitry 412 classifies the clouds based on color density (e.g., opacity, etc.) and the size of the cloud, and tracks changes in these factors to determine solar irradiance. In these examples, the cloud classification circuitry 412 monitors whether cloud density increases, cloud shape changes, cloud speed changes, and/or other characteristics of the cloud cover change to determine a corresponding change in solar irradiance. In some examples, an artificial intelligence model (e.g., a machine learning model such as a convolutional neural network (CNN), etc.) is implemented to detect the sun's position and classify cloud presence using metrics such as pixel saturation and brightness of an image. In these examples, the artificial intelligence model is a cloud model that predicts a presence of a cloud and sends the prediction of the cloud to another machine learning model for a prediction of solar irradiance. The cloud model can classify clouds, estimate the height of clouds, estimate the motion of clouds, and prediction occlusion of the clouds. In some examples, the cloud model is a set of models that can each determine at least one of a classification, a height, a motion, and/or an occlusion of a cloud. In some examples, the cloud classification circuitry 412 is instantiated by programmable circuitry executing cloud classification instructions and/or configured to perform operations such as those represented by the flowchart of FIG. 10 (blocks 1002-1004).

In some examples, the server circuitry 108 includes means for classifying clouds in an image. For example, the means for classifying clouds may be implemented by cloud classification circuitry 412. In some examples, the cloud classification circuitry 412 may be instantiated by programmable circuitry such as the example programmable circuitry 1512 of FIG. 15. For instance, the cloud classification circuitry 412 may be instantiated by the example microprocessor 1600 of FIG. 16 executing machine executable instructions such as those implemented by at least blocks 1002-1004 of FIG. 10. In some examples, the cloud classification circuitry 412 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the cloud classification circuitry 412 may be instantiated by any other combination of hardware, software, and/or firmware. For example, the cloud classification circuitry 412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The cloud processing circuitry 410 further includes the cloud motion estimation circuitry 414. The cloud motion estimation circuitry 414 tracks cloud motion. In some examples, the cloud motion estimation circuitry 414 applies optical flow and/or a maximum cross-correlation method to determine cloud motion. The cloud motion estimation circuitry 414 predicts cloud movement in short time intervals (e.g., 15 minute to 3 hours). Therefore, the prediction of cloud movement by the cloud motion estimation circuitry 414 helps to determine future solar irradiance as clouds significantly impact short-term solar irradiance.

In some examples, cloud motion is predicted by the cloud motion estimation circuitry 414 by sequential image sampling every 3-5 minutes, applying flow algorithms (e.g., Lucas-Kanade, Horn-Schunck, etc.) to consecutive frames of sampled images, identifying consistent vector fields using a direction and a magnitude, and projecting the cloud vectors forward in time relative to the solar azimuth and elevation to determine cloud motion. Some criteria can affect cloud motion such as cloud displacement between frames, consistency between features of the clouds, and time-stamped optical flow magnitudes. In some examples, the cloud motion estimation circuitry 414 is instantiated by programmable circuitry executing cloud motion estimation instructions and/or configured to perform operations such as those represented by the flowchart of FIG. 10 (block 1006).

In some examples, the server circuitry includes means for estimating cloud motion. For example, the means for estimating cloud motion may be implemented by cloud motion estimation circuitry 414. In some examples, the cloud motion estimation circuitry 414 may be instantiated by programmable circuitry such as the example programmable circuitry 1512 of FIG. 15. For instance, the cloud motion estimation circuitry 414 may be instantiated by the example microprocessor 1600 of FIG. 16 executing machine executable instructions such as those implemented by at least blocks 1006 of FIG. 10. In some examples, the cloud motion estimation circuitry 414 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the cloud motion estimation circuitry 414 may be instantiated by any other combination of hardware, software, and/or firmware. For example, the cloud motion estimation circuitry 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server circuitry 108 further includes the solar irradiance modeling circuitry 416. The solar irradiance modeling circuitry 416 determines a solar irradiance model for the geographic location 104. The solar irradiance modeling circuitry 416 estimates the solar irradiance model using luminance values extracted from the images. The solar irradiance modeling circuitry 416 can extract luminance values by converting red-green-blue values to grayscale or YCbCr luminance channels, applying gamma correction, and normalizing pixel brightness.

In some examples, the solar irradiance model generated by the solar irradiance modeling circuitry 416 is calibrated using ground-based historical sensor data. Further, in some examples, solar zenith angle and/or atmospheric transmittance are incorporated into the solar irradiance model to improve accuracy based on lighting conditions of the image. As used herein, solar zenith angle refers to the amount of irradiance reaching a specific location. The solar zenith angle affects how luminance values from an image of the sky are weighted based on the location where the image was taken. Therefore, the solar irradiance modeling circuitry 416 incorporates data from the cloud processing circuitry 410 (e.g., cloud cover, type, and movement), weather data (e.g., from the sensor panel 202), image data (e.g., data from the image processing circuitry 402), and the solar zenith angle and/or the atmospheric transmittance to determine the solar irradiance model. The solar irradiance model can be data corresponding to an estimated solar irradiance event (e.g., short-term future event) and/or data corresponding to a current solar irradiance event. Further, in some examples, the solar irradiance model circuitry 416 generates the solar irradiance model using a linear regression model where measured solar irradiance (e.g., values from the pyranometer 204 of FIG. 2, weather station values, etc.) is mapped to image-derived luminance values. In some examples, different regions of the sky image are weighed differently with areas near the sun (e.g., circumsolar regions) receiving higher weights.

In still other examples, the solar irradiance model circuitry 416 utilizes machine learning to predict a future solar irradiance event based on data received from the solar trackers 102. Artificial intelligence (AI), including machine learning (ML), deep learning (DL), and/or other artificial machine-driven logic, enables machines (e.g., computers, logic circuits, etc.) to use a model to process input data (e.g., weather data, images, etc.) to generate an output based on patterns and/or associations previously learned by the model via a training process. For instance, the model can be trained with data to recognize patterns and/or associates when processing input data such that other input(s) results in output(s) consistent with the recognized patterns or associations.

Many different types of machine learning models and/or machine learning architectures exist. In some examples disclosed herein, a Long Short Term Memory (LSTM) and/or a Convolutional Neural Network (CNN) is used. In general, machine learning models/architectures that are suitable to use in the examples disclosed herein will be a LSTM and/or a CNN. However, other types of machine learning models could additionally or alternatively be used such as Deep Neural Network (DNN), Recurrent Neural Network (RNN), Support Vector Machine (SVM), Gated Recurrent Unit (GRU), etc.

Many different types of machine learning models and/or machine learning architectures exist. In some examples disclosed herein, a convolutional neural network (CNN) is used. In general, machine learning models/architectures that are suitable to use in the example approaches disclosed herein will be Convolutional Neural Network (CNN) and/or Deep Neural Network (DNN), wherein interconnections are not visible outside of the model. However, other types of machine learning models could additionally or alternatively be used such as Recurrent Neural Network (RNN), Support Vector Machine (SVM), Gated Recurrent Unit (GRU), Long Short Term Memory (LSTM), etc.

In general, implementing a ML/AI system involves two phases, a learning/training phase and an inference phase. In the learning/training phase, a training algorithm is used to train a model to operate in accordance with patterns and/or associations based on, for example, training data. In examples herein, training data includes at least one of time-synced sky images, ground-truth irradiance (GHI) from pyranometers, environmental sensors (e.g., temperature, humidity, pressure, etc.), cloud vectors derived from optical flow, and solar angle data. The model can undergo supervised training with image-irradiance pairs annotated at time intervals (e.g., one minute, five minutes, etc.). Further, images can be synthesized by generative adversarial networks (GANs) for clouds that are under-represented in the training data. As such, images of clouds that are under-represented (e.g., cirrus, stratocumulus, etc.) in a data set can be paired with estimated irradiance values from physical models or empirical approximations for representation in the training data. Therefore, the model can be initially trained on large generic image data sets (e.g., ImageNet) and then fine-tuned on a smaller dataset of labeled sky images. The training procedure can include freezing initial convolutional layers to retain basic feature recognition and retaining the dense output layers using domain-specific irradiance targets. As such, the model can be employed in new regions without requiring extensive local training data.

In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training can be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs). In examples disclosed herein, ML/AI models are trained using labeled weather data and/or image data. The training using labeled weather data and/or image data occurs to normalize and embed each modality of data into separate vectors as the data is structurally different (e.g., time-series sensor data and image data, etc.). Accordingly, for the time-series sensor data, an LSTM or GRU model (e.g., a first machine learning model) can be implemented to generate a temporal vector and, for the image data, a CNN model (e.g., a second machine learning model) can be implemented to generate an image vector. The temporal vector and the image vector are then passed through fusion layers to prevent one modality from dominating another for the determination of solar irradiance. However, any other training data or algorithm may additionally or alternatively be used.

The solar irradiance model circuitry 416 includes first model circuitry 416a and second model circuitry 416b. The first model circuitry 416a can be instantiated by a long short-term memory model, for example, and used to analyze time-series weather data. In some examples, the first model circuitry 416a predicts future weather parameters using time-series weather data collected at the geographic location 104. In some examples, the first model circuitry 416a predicts future weather parameters for the geographic location 104 and areas surrounding the geographic location 104. In these examples, the first model circuitry 416a uses as input recently collected data, processes the data into a tensor, uses a pre-trained long short-term memory model to make predictions based on the tensor, and inversely scales the outputs to produce meaningful forecast data. A training data set for the pre-trained long short-term memory model can include at least one of tens of thousands of labeled image frames, GHI readings of image frames, solar angle and time metadata, sensor data (e.g., temperature, pressure, humidity, etc.), and cloud motion fields from sequential frame differences. The first model circuitry 416a can include two long short term memory layers with sixty four units and thirty two units. The first model circuitry 416a can output predictions (e.g., solar irradiance values) for a given period of time (e.g., five minutes, fifteen minutes, etc.).

The second model circuitry 416b can be a machine learning model such as a convolutional neural network model and is used to analyze images. In some examples, the second model circuitry 416b predicts light intensity based on a last collected image by the solar tracker 102. In these examples, the second model circuitry 416b processes images to an input shape and normalization, uses a pre-trained convolutional neural network model to predict future light intensity values, and adjusts and inversely scales the predictions to obtain the light intensity values. In other words, the second model circuitry 416b corrects the raw images captured by the camera and extracts features from the images. Further, for input into the second model circuitry 416b, the data can be normalized, images can be resized, gamma correction can be applied, and/or daylight filtering can be performed (e.g., removes nighttime frames, etc.). Then, the second model circuitry 416b merges the feature data and predictions from the first model and/or weather data. After the merger of the data, the second model circuitry 416b can output solar irradiance predictions for a short-term solar irradiance forecast. In some examples, the second model circuitry 416b transforms the output via smoothing, quantile regression scaling, and/or saturation clipping. In some examples, the second model circuitry 416b predicts solar irradiance levels using seven layers of a convolutional neural network. The seven layers can include three convolutional layers, two pooling layers, one flatten layers, and two fully connected layers.

In some examples, the first model and the second model process the data simultaneously (e.g., the first model processes time-series weather data at the same time that the second model processes images to infer light intensity). In other examples, the first model and the second model perform their operations in sequence (e.g., the first model performs operations before and/or after the second model).

In some examples, the solar irradiance modeling circuitry 416 is instantiated by programmable circuitry executing solar irradiance modeling instructions and/or configured to perform operations such as those represented by the flowchart of FIG. 8 (block 806).

In some examples, server circuitry includes means for determining a solar irradiance model. For example, the means for determining a solar irradiance model may be implemented by solar irradiance modeling circuitry 416. In some examples, the solar irradiance modeling circuitry 416 may be instantiated by programmable circuitry such as the example programmable circuitry 1512 of FIG. 15. For instance, the solar irradiance modeling circuitry 416 may be instantiated by the example microprocessor 1600 of FIG. 16 executing machine executable instructions such as those implemented by at least block 806 of FIG. 8. In some examples, the solar irradiance modeling circuitry 416 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the solar irradiance modeling circuitry 416 may be instantiated by any other combination of hardware, software, and/or firmware. For example, the solar irradiance modeling circuitry 416 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server circuitry 108 further includes post-processing circuitry 418. The post-processing circuitry 418 outputs the solar irradiance model. In some examples, the post-processing circuitry 418 applies post-processing techniques to smooth data corresponding to the solar irradiance model prior to output. In these examples, the post-processing techniques smooth the data to account for sudden changes in irradiance due to cloud cover. Smoothing removes high-frequency noise, and can include performance of at least one of a rolling average, Savitzky-Golay filter, or an exponential moving average.

Further, the post-processing circuitry 418 can evaluate the performance of the solar irradiance model as a forecast model by comparing the solar irradiance model's predictions with solar irradiance measured at ground stations. For example, the post-processing circuitry 418 compares a measurement of solar irradiance at a ground station to a measurement prediction by the forecast model. In these examples, the post-processing circuitry 418 applies root-mean-square error and/or Spearman's rank correlation coefficient to quantify the accuracy of the solar irradiance model. In some examples, a root-mean-square value less than 80 Watts per meter squared and/or a Spearman's rank correlation coefficient of greater than 0.70 indicate strong accuracy of the solar irradiance model (e.g., a correlation greater than 0.85).

In other examples, the post-processing circuitry 418 evaluates the solar irradiance model against other solar irradiance estimation techniques (e.g., satellite-based models and/or traditional meteorological models) to confirm the performance of the solar irradiance model in capturing rapid irradiance fluctuations. The post-processing circuitry 418 can evaluate the solar irradiance model by modeling predicted GHI and comparing that GHI against values produced by the pyranometer. In some examples, the post-processing circuitry 418 is instantiated by programmable circuitry executing post-processing instructions and/or configured to perform operations such as those represented by the flowchart of FIG. 8 (block 808).

In some examples, server circuitry includes means for post-processing a solar irradiance model. For example, the means for post-processing a solar irradiance model may be implemented by post-processing circuitry 418. In some examples, the post-processing circuitry 418 may be instantiated by programmable circuitry such as the example programmable circuitry 1512 of FIG. 15. For instance, the post-processing circuitry 418 may be instantiated by the example microprocessor 1600 of FIG. 16 executing machine executable instructions such as those implemented by at least block 808 of FIG. 8. In some examples, the post-processing circuitry 418 may be instantiated by hardware logic circuitry, which may be implemented by an ASIC, XPU, or the FPGA circuitry 1700 of FIG. 17 configured and/or structured to perform operations corresponding to the machine readable instructions. Additionally or alternatively, the post-processing circuitry 418 may be instantiated by any other combination of hardware, software, and/or firmware. For example, the post-processing circuitry 418 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server circuitry 106 further includes the database 420. The database 420 stores data for long-term storage. In some examples, the database 420 stores data for use to train and validate a machine learning model to forecast solar irradiance events based on data collected by the solar tracker 102. In some examples, the database 420 provides to a user interface (e.g., of the solar tracker 102, a mobile device, a user device, etc.) the most recent stored data for user viewing and/or input.

While an example implementation of the server circuitry 108 of FIG. 2 is illustrated in FIG. 4 one or more of the elements, processes, and/or devices illustrated in FIG. 4 may be combined, divided, re-arranged, omitted, eliminated, and/or implemented in any other way. Further, the example image processing circuitry 402, the example image segmentation circuitry 404, the example image conversion circuitry 406, the example image correction circuitry 408, the example cloud processing circuitry 410, the example cloud classification circuitry 412, the example cloud motion estimation circuitry 414, the example solar irradiance modeling circuitry 416, the example post-processing circuitry 418, the example database 420, and/or, more generally, the example server circuitry 108 of FIG. 4, may be implemented by hardware alone or by hardware in combination with software and/or firmware. Thus, for example, any of the example image processing circuitry 402, the example image segmentation circuitry 404, the example image conversion circuitry 406, the example image correction circuitry 408, the example cloud processing circuitry 410, the example cloud classification circuitry 412, the example cloud motion estimation circuitry 414, the example solar irradiance modeling circuitry 416, the example post-processing circuitry 418, the example database 420, and/or, more generally, the example server circuitry 108, can be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example server circuitry 108 of FIG. 4 may include one or more elements, processes, and/or devices in addition to, or instead of, those illustrated in FIG. 4, and/or may include more than one of any or all of the illustrated elements, processes and devices.

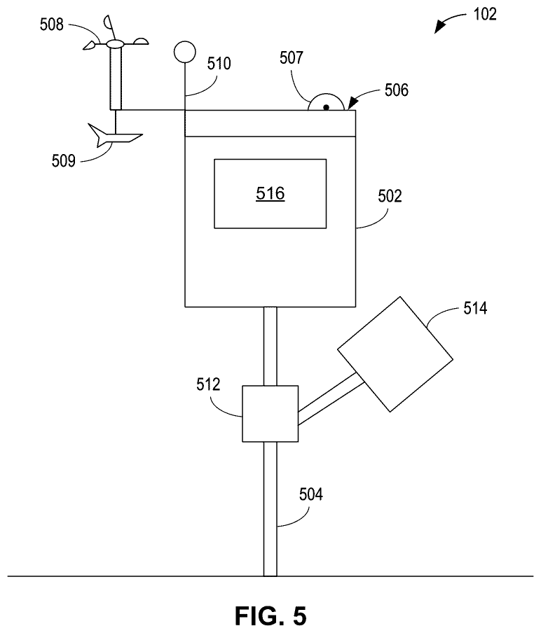

FIG. 5 is an example implementation of the solar tracker 102 of FIG. 1. The solar tracker 102 of FIG. 5 includes a casing 502 to house the circuitry and control elements illustrated in connection with FIG. 2. In some examples, the casing 502 is weatherproof. While a square box is shown in FIG. 5, the casing 502 can be any shape, size, and/or other implementation for the solar tracker 102.

The solar tracker 102 further includes a pole 504. The pole 504 is fastened near the geographic location 104. The pole 504 can be made of any material (e.g., metal, plastic, etc.), and can be any suitable length. Further, in some examples, the pole is inserted into the ground near the geographic location 104. In other examples, the pole ends with a fastener attachment (e.g., a suction cup, a clamp, a screw connection, etc.) to allow the solar tracker 102 to be attached to a structure (e.g., a fence, a building, etc.) near the geographic location 104.

The solar tracker 102 further includes a sensor panel 506. The sensor panel 506 can include the sensors depicted in the sensor panel 202 of FIG. 2. The sensor panel 506 can include protection for the sensor panel from the weather (e.g., boxes around circuitry elements of the sensors, etc.).

The solar tracker 102 further includes a camera 507 placed on the exterior of the casing 502. As described above, in some examples, the camera 507 is an all sky imager configured to take panoramic views of the sky.

The solar tracker 102 further includes an anemometer 508. The anemometer 508, in this example, is located outside the sensor panel 506 to measure wind speed and direction. In some examples, the anemometer 508 further includes and/or is configured with a wind vane 509. In these examples, the wind vane 509 measures the direction of the wind.

The solar tracker 102 further includes an antenna 510. The antenna 510 enables wireless transmission of collected data. The antenna 510 can wirelessly transmit the data using cellular transmission.

The solar tracker 102 further includes a battery 512. The battery 512 can be a lithium ion battery and/or any other type of battery. In some examples, the health of the battery is monitored by the solar tracker 102 (e.g., by a processor circuit, etc.). In these examples, if the health of the battery falls below a threshold, a battery notification is displayed to the user (e.g., via an interface, a mobile application on a user device, etc.). The battery 512 can be further encased by a battery compartment to protect the battery from the weather conditions.

The solar tracker 102 further includes a solar panel 514. The solar panel 514 can communicate with the battery 512 to determine whether an amount of solar energy is converted by the solar panel 514 to power the solar tracker 102.

The solar tracker 102 further includers a user interface 516. The user interface 516 displays information regarding the solar tracker 102 to the user. In some examples, the user interface 516 displays data collected by the solar tracker 102 (e.g., a temperature of the geographic location 104, etc.), information regarding health of the battery 512, information regarding a charge from the solar panel 514, and/or other information regarding a status of the solar tracker 102. In some examples, the user interface 516 displays line charts to visualize solar irradiance, temperature, humidity, wind speed, and/or rain. Further, the user interface 516 can display a thermometer chart to show the temperature in various metrics (e.g., Fahrenheit, Celsius, etc.). Further, the user interface 516 can display a sequence of images captured by the camera 507 to visualize weather changes over time. In some examples, the user interface 516 accepts user input for a user to click on charts associated with data, manipulate the data (e.g., display selected time intervals, selected sensor data, display an image when a data point is selected, etc.), and send the data output to an external program (e.g., export the data).

Flowcharts representative of example machine readable instructions, which may be executed by programmable circuitry to implement and/or instantiate the controller circuitry 224 of FIG. 3 and/or representative of example operations which may be performed by programmable circuitry to implement and/or instantiate the controller circuitry 224 of FIG. 3, are shown in FIGS. 6-7. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-7, many other methods of implementing the example controller circuitry 224 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to collect data (e.g., weather conditions, images, etc.) at the solar tracker 102 corresponding to a solar irradiance event at the geographic location 104 for transmission to the server 106 of FIG. 1 to determine and/or model a solar irradiance event. The example machine-readable instructions and/or the example operations 600 of FIG. 6 begin at block 602, at which the data collection circuitry 302 collects data corresponding to a weather condition. The data collected corresponding to the weather condition can be sensor data collected by sensors located in the sensor panel 202 of FIG. 2 (e.g., the pyranometer 204, the camera 206, the hygrometer 208, the barometer 210, the thermometer 212, the anemometer 214, the solar panel 216, the rain gauge 218, etc.). The data collection circuitry 302 can collect the data by sampling over a certain period of time (e.g., every minute for thirty minutes, etc.) and/or can collect the data based on a user input to collect data (e.g., a user transmission to the solar tracker 102 to collect data). For example, the solar tracker 102 collects data that it is raining at the geographic location 104 at which the solar tracker 102 is located.

At block 604, the collected weather data is encoded for transmission to the server 106 by the data encoder circuitry 304. The data encoder circuitry 304 encodes the data by receiving data from the solar tracker 102 at the geographic location 104 of FIG. 1. Once data is received, the data is recorded for each sensor at a sampling interval (e.g., 100 samples per second, etc.). After the data is recorded, the data is labelled corresponding to the geographic location 104 and grouped based on time of sampling. In some examples, the data is labelled and grouped so that sensor readings (e.g., temperature, humidity, irradiance, wind speed, etc.) can be organized into key-value pairs for parsing. In some examples, the data is encoded for transmission in various data formats (e.g., JavaScript Object Notation, Extensible Markup Language, Protobuf, Concise Binary Object Representation, Comma-Separated Values, Base64 Encoding, Hybrid Encoding, etc.). In some examples, the data encoder circuitry 304 validates the quality of the data before transmission to the server 106. In these examples, the data encoder circuitry 304 determines whether the quality of the data is above a threshold quality for transmission to the server 106. In further examples, the data encoder circuitry 304 filters the data to reduce redundant and/or low quality measurements. Further, in some examples, the data encoder circuitry 304 encrypts some or all of the encoded data to ensure secure transmission to the server 106. In some examples, the collected weather data corresponds to rain at the geographic location 104 of the solar tracker 102 and is grouped based on the time of the sampling so that the weather data shows an increase in precipitation over time. Further, in some examples, the encoded data is compressed before transmission to reduce the size of data transmitted to the server 106.

At block 606, the packaged data (e.g., labelled based on geographic location 104 and grouped based on time) is sent for further processing (e.g., determination of a solar irradiance event, generation of a solar irradiance model, etc.) to the server 106 by the data transmission circuitry 310. The data transmission circuitry 310 can send the packaged data via wireless or wired transmission. The data collected by the solar tracker 102 (e.g., cloud cover, precipitation, wind speed, etc.) and sent to the server 106 determines the solar irradiance event and/or the solar irradiance model to determine future solar irradiance events. In some examples, communication between the solar tracker 102 and the server 106 is instantiated via an HTTPS protocol, Message Queuing Telemetry Transport (MQTT) protocol, Advanced Message Queuing Protocol (AMQP), File Transfer Protocol, Secure File Transfer Protocol, Simple Mail Transfer Protocol, WebSocket Protocol, SSH-based Protocols, Bluetooth/Wi-Fi data sharing, LoRaWAN, cloud-based platforms, and/or radio/microwave transmission.

MQTT is a lightweight, publish-subscribe model for Internet of Things applications. MQTT can allow each solar tracker 102 to act as a client and publish data (e.g., temperature, cloud cover, solar irradiance, etc.). The server 106, as a subscriber, aggregates the data in real-time, ensuring low latency and reliable delivery even in locations with intermittent cellular connectivity. MQTT supports frequent, small-packet transmission required for short-term solar forecasts.

AMQP can be used for deployments requiring more robust workflows as AMQP can perform message queuing, acknowledgments, and routing. AMQP allows management of large volumes of data from distributed solar trackers 102 to ensure that messages are reliably delivered even during network disruptions. In particular, AMQP is useful when scaling the network to include multiple solar trackers 102 over a broad geographic area as message handling workflows can become more complex.

FTP and SFTP can be used to batch upload structured data, such as daily logs of sensor readings or high-resolution sky imagery from the solar trackers 102. FTP/SFTP can be used to periodically back up locally stored data from each solar tracker 102 to the server 106. SFTP's encryption ensures secure transmission. In some examples, secure transmission is used for the sending of sensitive or proprietary forecasting data.

SMTP can be used to send structured sensor data (e.g., CSV files) as email attachments to the server 106. SMTP ensures data integrity when direct server 106 communication is temporarily unavailable.

Further, data can also be securely transferred using SSH-based protocols, like Secure Copy Protocol (SCP) or RSYNC. In particular, SSH-based protocols can be used when synchronizing large batches of locally stored data (e.g., sky imagery, historical sensor readings, etc.) with the server 106. In some examples, RSYNC reduces data usage by only transmitting changes in data (e.g., a change in precipitation, etc.) so that it is an efficient option to optimize bandwidth in remote deployments of solar trackers 102.

In examples in which solar trackers 102 are deployed in clusters, Bluetooth or Wi-Fi Direct enable short-range communication between the solar trackers 102. The short-range communication enables sharing of data with a local gateway before forwarding the data to the server 106. By pooling data prior to forwarding to the server 106, cellular data usage is reduced.

In examples in which solar trackers 102 are deployed in remote or rural areas, LoRaWAN is an energy-efficient, long-range communication protocol. In particular, LoRaWAN can be implemented when solar trackers 102 are installed in isolated regions without reliable cellular or internet access.

In examples in which solar trackers 102 are fixed in areas with access to network infrastructure, Ethernet connections are used for data transmission. Ethernet provides a high-speed, low-latency option for transmission of data from the solar tracker 102.

In some examples, cloud-based Internet of Things (IoT) platforms are used for data transmission from the solar tracker 102 to the server 106. The solar trackers 102 can transmit the data directly to the cloud (as the server 106), where the data can be processed, analyzed, and stored.

In some examples in which solar trackers are dispersed far apart geographically, radio and microwave transmission are used. By using radio frequencies or microwave links, the system can transmit data directly from the solar trackers 102 to a relay hub or server 106. In some examples, radio and/or microwave transmission are used when solar trackers 102 are deployed in areas with challenging terrain or low population density. After transmission from the solar trackers 102 to the server 106, the prediction of the solar irradiance occurs.

FIG. 7 is a flowchart representative of example machine readable instructions and/or example operations 604 that may be executed, instantiated, and/or performed by programmable circuitry to encode data collected by the solar tracker 102 for transmission to the server 106 of FIG. 1. The data is encoded according to the time and location of collection to enable precise determination of solar irradiance events. The example machine-readable instructions and/or the example operations 604 of FIG. 7 begin at block 702, at which the data recordation circuitry 306 determines whether data is received from a plurality of sensors of the solar tracker 102 for a geographic location 104. In some examples, the data recordation circuitry 306 receives data from some sensors and not others (e.g., receives data from the camera 206 but not from the hygrometer 208 of the sensor panel 202). In other examples, the data recordation circuitry 306 receives data from all sensors of the sensor panel 202 of FIG. 2. In some examples, the data recordation circuitry 306 receives data that it is raining at the geographic location 104 (e.g., rain gauge, barometer, solar panel, etc.), but there is little wind so no data corresponding to wind (e.g., pyranometer) is collected.

At block 704, the data recordation circuitry 306 determines whether a threshold amount of data is received from the sensors of the sensor panel 202 of FIG. 2. In some examples, a threshold amount of data is received when data from a sensor reaches the threshold and/or data from a plurality of sensors reaches the threshold. In these examples, a threshold refers to a threshold change in irradiance detections. Accordingly, if a change in GHI between readings surpasses a threshold, the change indicates an irradiance value to be sent from the sensor panel 202.

In other examples, the threshold amount of data is received from the sensors when there is data corresponding to each sensor received by the data recordation circuitry 306. In some examples, the data recordation circuitry 306 determines a threshold amount of data has been received if an amount of time has passed (e.g., 5 minutes, etc.). In some examples, the threshold amount of data is determined based on the location of the solar tracker 102 (e.g., remote deployment versus urban deployment). In examples where the solar tracker 102 is deployed in a remote location, a lower frequency of data capture (e.g., threshold amount of data is higher and/or time between data transmissions is higher) is used to save power and cellular data usage. In examples where the solar tracker 102 is deployed in an urban location, a higher frequency of data capture (e.g., threshold amount of data is lower and/or time between data transmissions is lower) is used as wired power and/or Ethernet transmission can be implemented. If the threshold amount of data is not received from the sensors (block 704: NO), control returns to block 602 to receive more data corresponding to the plurality of sensors of the sensor panel 202 of the solar tracker 102. If the threshold amount of data is received from the sensors (block 704: YES), control proceeds to block 606.

At block 706, the data recordation circuitry 306 records data from the plurality of sensors of the sensor panel 202 at a sampling interval. In some examples, the sampling interval is 100 samples per second. However, the sampling interval can be any sampling interval. In some examples, the data recordation circuitry 306 uses the sampler 222 of the solar tracker 102 to sample the received data. After the received data is sampled, control proceeds to block 708.

At block 708, the data packaging circuitry 308 labels the data based on the geographic location 104 of the solar tracker 102 of FIG. 1. The data packaging circuitry 308 labels the data based on the geographic location 104 of the solar tracker 102 so that when the data is later compared to other locations (e.g., data from other solar trackers 102) the data is traceable to the geographic location 104 of the original solar tracker 102. In some examples, the data packaging circuitry 308 labels the data based on the geographic location 104 using georeferenced coordinates, GPS coordinates, latitude and longitude coordinates, and/or another geographic location label. After the data is labelled based on the geographic location 104, control proceeds to block 710.

At block 710, the labelled data is grouped based on the time of sampling by the data packaging circuitry 308. The data packaging circuitry 308 organizes the data so that data that is sampled at the same time (e.g., at the same time interval) is grouped together and labelled based on the timestamps. Therefore, data is transmitted to the server grouped based on the geographic location 104 and the time of sampling (e.g., time of sampling recorded in block 706) to enable precise irradiance event determinations for the geographic location 104. After the data is grouped, control returns to block 606 of FIG. 6. Transmission of grouped data to the server 106 enables the determination of current and/or future solar irradiance events, the determination of the solar irradiance model, and/or the display of the data for viewing and/or input by the user.

Flowcharts representative of example machine readable instructions, which may be executed by programmable circuitry to implement and/or instantiate the server circuitry 108 of FIG. 4 and/or representative of example operations which may be performed by programmable circuitry to implement and/or instantiate the server circuitry 108 of FIG. 4, are shown in FIGS. 8-13. The machine readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by the example programmable circuitry (e.g., an FPGA) discussed below in connection with FIGS. 16 and/or 17. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-13, many other methods of implementing the example server circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to determine a solar irradiance model. The example machine-readable instructions and/or the example operations 800 of FIG. 8 begin at block 802, at which the image processing circuitry 402 performs image processing on images collected of the sky by the camera 206 of FIG. 2 included in the solar tracker 102 of FIG. 1. In some examples, the image processing of the images determines cloud cover and other details of images relevant to the determination of solar irradiance. In some examples, the image processing performed by the image processing circuitry 402 causes image segmentation, color conversion, and gamma correction of an image obtained by the camera 206 of FIG. 2. In other examples, the image processing circuitry 402 processes the image using at least one of image segmentation, color conversion, gamma correction, and/or any other image processing technique. Further, the image processing circuitry 402 can perform image processing on images collected at varying geographic locations from a plurality of solar trackers (e.g., the plurality of solar trackers 102 at the geographic location 104 shown in FIG. 1, other solar trackers at another geographic location, etc.). After image processing is performed by the image processing circuitry 402, control proceeds to block 804.

At block 804, the cloud processing circuitry 410 processes cloud cover and motion. In some examples, the cloud processing circuitry 410 processes cloud cover and motion based on images collected by the camera 206. The images analyzed for cloud cover and motion can be from the same geographic location 104 (e.g., the same solar tracker 102 and/or solar trackers 102 located around the same geographic location 104, etc.) and/or solar trackers located near the geographic location 104. In some examples, the images are processed to determine a cloud type and/or height. Further, the movement of the clouds can be processed to determine a predicted instance of cloud cover and an effect on solar irradiance at a future time. In some examples, images of clouds are sampled every 3-5 minutes to form a sequence of images, and optical flow is calculated to determine cloud movement over time. Therefore, a cloud vector can be projected to the future time to determine the predicted instance of cloud cover based on at least a speed of the clouds, a direction of movement of the clouds, the position of the sun, and/or the altitude of the clouds. After processing cloud cover and motion, control proceeds to block 806.

At block 806, the solar irradiance modeling circuitry 416 generates a solar irradiance model. In some examples, the solar irradiance model is a data output corresponding to a current and/or a future solar irradiance event (e.g., a current and/or predicted solar irradiance value). In other examples, the solar irradiance model is an interactive model (e.g., accepts user input and/or user manipulation of the model) corresponding to the current and/or the future solar irradiance event. In some examples, the solar irradiance model is trained using supervised learning (e.g., backpropagation, Adam optimizer, labelled irradiance data, time-matched images, etc.). The solar irradiance modeling circuitry 416 can generate the solar irradiance model based on luminance values extracted from images from the camera, the solar zenith angle from the images, and the atmospheric transmittance of the images. Further, the solar irradiance model is generated using the data collected by the solar tracker 102. In some examples, the model is abstracted down to a file to be deployed on edge devices, cloud servers, docker containers, and other deployment devices that can host the model to generate inferences and output results. After generation of the solar irradiance model, control proceeds to block 808.

At block 808, the post-processing circuitry 418 outputs the model. In some examples, the post-processing circuitry 418 processes the model to perform error calculation and data smoothing. In other examples, the post-processing circuitry 418 outputs the model to the user (e.g., to client devices 110, 112, 114) as it was generated (e.g., as generated at block 806). The model can be displayed via a user interface for user interaction and/or input. The model can be used to determine future solar irradiance events based on data collected by the solar tracker 102. After the output of the model at block 808, the process ends.

FIG. 9 is a flowchart representative of example machine readable instructions and/or example operations 802 that may be executed, instantiated, and/or performed by programmable circuitry to perform image processing. In some examples, the images collected include varying cloud cover and luminance to aid the determination of solar irradiance. The example machine-readable instructions and/or the example operations 802 of FIG. 9 begin at block 902, at which the image segmentation circuitry 404 segments images received from camera 206 of the solar tracker 102 of FIG. 1. To separate areas with variation in luminance, the image segmentation circuitry 404 segments the images into regions based on proximity to the sun (e.g., segments the images in three zones based on closeness to the sun). In some examples, the image segmentation circuitry 404 segments the image by calculating the Euclidean distance of each pixel to the sun to define areas of interest. The images can be segmented into any number of areas of interest (e.g., any number of zones). After segmentation of the images, control proceeds to block 904.

At block 904, the image conversion circuitry 406 converts the RGB color model of the image to the HSV color model. In this example, the image conversion circuitry 406 converts the color scale of the image to the HSV color model, but, in other examples, the image conversion circuitry 406 converts the color model of the image to another color scale (e.g., cyan magenta yellow key (CMYK), hue saturation lightness (HSL), Pantone, etc.). The image conversion circuitry 406 converts the image to extract values from the image at the pixel level. In some examples, the image conversion circuitry 406 extracts pixel-level values from the RGB image and the HSV image. After image conversion and value extraction, control proceeds to block 906.

At block 906, the image correction circuitry 408 performs image correction on the converted image. In some examples, the image correction includes gamma correction correct non-linearities in the image data of the image to ensure that luminance values collected from the image correlate with actual solar irradiance. Gamma correction compensates for the non-linear response of camera sensors. Without correction, clouds can appear artificially bright or dark. Accordingly, the image correction circuitry 408 linearizes the intensity of the image data to ensure that the model can correctly interpret luminance, cloud opacity, and/or brightness gradients.

In other examples, other forms of image correction are implemented (e.g., linear contrast stretching, histogram equalization, atmospheric scattering model, edge detection, spatial filtering, principal component analysis, image binarization, Fourier transform based processing, image normalization, etc.). After image correction is performed, control proceeds to block 804 of FIG. 8. After the image is processed, clouds included in the image are processed to determine solar irradiance of the geographic location 104 despite the presence of clouds above the geographic location 104.

FIG. 10 is a flowchart representative of example machine readable instructions and/or example operations 804 that may be executed, instantiated, and/or performed by programmable circuitry to process cloud cover and motion in images collected by the camera 206 of FIG. 2. The example machine-readable instructions and/or the example operations 804 of FIG. 10 begin at block 1002, at which the cloud classification circuitry 412 detects clouds based on a cloud detection algorithm. Clouds can be detected based on a machine learning model or other image thresholding technique to determine whether a cloud is located in a pixel of an image. After a cloud is detected, control proceeds to block 1004.

At block 1004, the cloud classification circuitry 412 classifies detected clouds. In some examples, the cloud classification circuitry 412 classifies the detected clouds based on type and height. In other examples, the clouds are classified based on other characteristics (e.g., density, fog, etc.). In some examples, cloud cover percentage, luminance, and radiance values are extracted from different zones of the image. In some examples, the zones of the images are classified based on a distance from the sun (e.g., a region that has a greater impact on solar irradiance is closest to the sun, etc.). Therefore, values that are extracted from the zones that are closest to the sun affect the predictions of solar irradiance more than values that are extracted from zones farther away from the sun. After cloud classification is performed, control proceeds to block 1006.

At block 1006, cloud motion is determined by the cloud motion estimation circuitry 414. The cloud motion estimation circuitry 414 determines cloud motion to predict future cloud movement over short time intervals. The prediction can be performed using optical flow and/or maximum cross-correlation methods. The prediction of the future position of clouds enhances the accuracy of short-term irradiance models. After cloud motion is estimated, control returns to block 806 of FIG. 8. The prediction of cloud motion and cover is used to determine the solar irradiance model as clouds affect the amount of solar luminance that reaches the solar trackers 102. Therefore, the predictions of cloud motion and cover can lead to more accurate determinations of current and future solar irradiance events.

FIG. 11 is a flowchart representative of example machine readable instructions and/or example operations 806 that may be executed, instantiated, and/or performed by programmable circuitry to model solar irradiance. The example machine-readable instructions and/or the example operations 806 of FIG. 11 begin at block 1102, at which the first model circuitry 416a performs data processing using the first machine learning model. The first model circuitry 416a uses the first machine learning model to receive the time-series weather data, transform the data into a tensor, and generate predictions based on the tensor. Further, the first model circuitry 416a can organize the data based on timestamp to synthesize with other data sets and/or predictions (e.g., data output by the second machine learning model, etc.).

At block 1104, the second model circuitry 416b performs image processing using the second machine learning model. The second model circuitry 416b receives image data, processes the image data via normalization, correction, and feature extraction, and merges extracted features with the output of the first model circuitry 416b. Accordingly, in some examples, the features extracted by the second model circuitry 416a are merged with the time-series weather data output by the first model circuitry 4316b according to timestamps of the data.

FIG. 12 is a flowchart representative of example machine readable instructions and/or example operations 1102 that may be executed, instantiated, and/or performed by programmable circuitry to perform data processing using the first machine learning model. The example machine-readable instructions and/or the example operations 1102 of FIG. 11 begin at block 1202, at which the first model circuitry 416a receives time-series collected weather data. The time-series collected weather data can include data from one or more of the pyranometer 204, the hygrometer 208, the barometer 210, the thermometer 212, the anemometer 214, the solar panel 216, and the rain gauge 218. However, the time-series weather data can include data from any other sensor included in the sensor panel 202. In some examples, the time-series collected weather data is received by the first model circuitry 416a on an iterative basis (e.g., every 3-5 minutes) or is received in a single packet including time-series data including multiple time periods.

At block 1204, the first model circuitry 416a applies preprocessing and normalization to the collected weather data. The first model circuitry 416a preprocessing and normalization can include missing data imputation, scaling, timestamp alignment, and feature engineering. The first model circuitry 416a can input data that is missing into the data set to ensure a complete data set (e.g., input a missing data point based on an interval of time for collection of data, etc.). The first model circuitry 416a can further scale the data so that the collected data of each type is represented equally in the data set. Further, the first model circuitry 416a can organize the data sets of collected weather data to align the data based on timestamp (e.g., data collected at a first time interval is grouped together, data collected at a second time interval is grouped together, etc.). The first model circuitry 416a can further perform feature engineering to condense the data set and/or extract features to represent the collected weather data. In some examples, the feature engineering includes performance of a rolling average to represent data that is collected over time in a condensed average format.

At block 1206, the first model circuitry 416a processes the data into a tensor. The tensor formed by the first model circuitry 416a represents the collected weather data over a certain period of time (e.g., a certain number of time intervals of data collection, a given day, a month, from a first date to a second date, etc.). In some examples, the first model circuitry 416a updates the tensor with data collected after the formation of the tensor.

At block 1208, the first model circuitry 416a applies temporal smoothing or trend features to the tensor. The first model circuitry 416a can smooth variations between data over time to improve detection of changes that indicate a solar irradiance event. In some examples, the first model circuitry 416a does not apply the temporal smoothing or trend features to the tensor and control proceeds directly to block 1210. However, in other examples, the user elects and/or, if the data is noisy, the first model circuitry 416a applies the temporal smoothing or trend features.

At block 1210, the first model circuitry 416a generates predictions based on the tensor. In some examples, the first model circuitry 416a is instantiated by a long short-term memory model. The predictions generated by the first model circuitry 416a can include predictions of future weather events based on the collected time-series weather data. The future weather events predicted by the first model circuitry 416a can inform predictions of solar irradiance. For example, if the first model circuitry 416a generates a prediction that it will be raining in twenty minutes, the solar irradiance model can further extrapolate that solar irradiance will be lower. In this example, the first model circuitry 416a generates the prediction based on collected time-series weather data indicating that clouds are forming.

At block 1212, the first model circuitry 416a can evaluate prediction confidence. The first model circuitry 416a can apply quantile thresholds and/or confidence bands to measure a confidence in the accuracy of the prediction. In the example above, the first model circuitry 416a generates the prediction that it will rain and then output a confidence value in the prediction based on previous events where clouds were forming and it rained. The quantile thresholds of the first model circuitry 416a can allow for forecasting of energy to enable an operator to assess risk profile of an energy management strategy across forecasting windows.

At block 1214, the first model circuitry 416a can inversely scale the prediction to generate the output. The first model circuitry 416a can inversely scale the prediction to determine a future weather event at a predetermined time. Accordingly, based on the above example, the first model circuitry 416a outputs the predicted future rain event with a predicted time of performance.

At block 1216, the first model circuitry 416a can log the output with a timestamp to storage. In some examples, the first model circuitry 416a logs the output to local or remote storage. Further, the timestamp includes the timestamps of the future weather event. Further, the first model circuitry 416a can store the future weather event for retraining of the first machine learning model and/or validation of prediction (e.g., generation of confidences, etc.). After logging the output, control returns to block 1104.

FIG. 13 is a flowchart representative of example machine readable instructions and/or example operations 1104 that may be executed, instantiated, and/or performed by programmable circuitry to perform data processing using the second machine learning model. The example machine-readable instructions and/or the example operations 1104 of FIG. 11 begin at block 1302, at which the second model circuitry 416b normalizes and/or corrects an input image. The normalization and/or the correction of the second model circuitry 416b can include gamma correction to linearize image intensity. Further, the second model circuitry 416b can receive images corrected by the image correction circuitry 408. The second model circuitry 416b can include radial distortion correction to adjust for curvature of the camera 507. Further, the second model circuitry 416b can further correct white balance of an image and normalize a dynamic range of the image. The second model circuitry 416b can additionally or alternatively mask out non-sky regions (e.g., parts of the camera housing).

At block 1304, the second model circuitry 416b extracts features from the image using the second machine learning model. The extracted features can include features relevant to clouds and/or solar irradiance. In some examples, the second model circuitry 416b includes features to inform cloud coverage, cloud type, cloud opacity, cloud edges and gradients, and sun occlusion. In some examples, the second model circuitry 416b uses the second machine learning model to extract solar irradiance predictions from the images. Further, the second model circuitry 416b can extract features related to cloud motion and/or cloud motion predictions generated by the cloud motion estimation circuitry 414.

At block 1306, the second model circuitry 416b merges the extracted feature (e.g., luminance value, cloud pattern, etc.) with the output of the first model (e.g., precited future weather event, etc.). The second model circuitry 416b can merge the outputs via concatenation or attention-based fusion. The merger can include synchronized embedding across time stamps between the images and the time-series weather data, dynamic input stream weighting based on availability of data, and fallback to either image or time-series data based on a sensor failure (e.g., if the camera fails, predictions based on times-series weather data alone are generated, etc.). Accordingly, a solar irradiance prediction based on the fusion of these two data sources can be made. After the merger of the extract feature with the output of the first model, control returns to block 808.

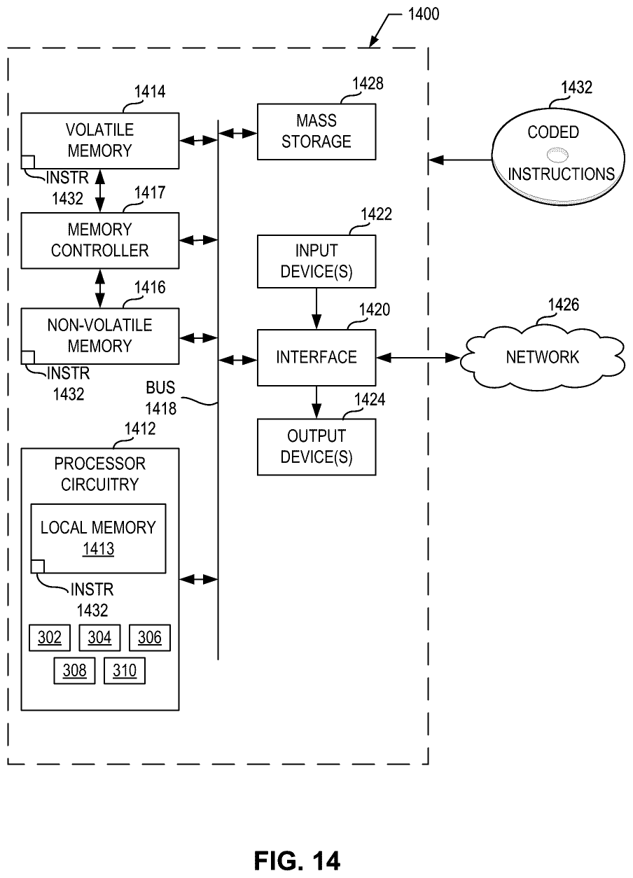

FIG. 14 is a block diagram of an example programmable circuitry platform 1400 structured to execute and/or instantiate the example machine-readable instructions and/or the example operations of FIGS. 6-7 to implement the controller circuitry of FIG. 3. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the data collection circuitry 302, the data encoder circuitry 304, the data recordation circuitry 306, the data packaging circuitry 308, and the data transmission circuitry 310.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIGS. 6-7, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 6-7 to effectively instantiate the circuitry of FIG. 3 as logic circuits to perform operations corresponding to those machine readable instructions. In some such examples, the circuitry of FIG. 3 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 6-7.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowchart(s) of FIGS. 6-7 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-7. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-7. As such, the FPGA circuitry 1600 may be configured and/or structured to effectively instantiate some or all of the operations/functions corresponding to the machine readable instructions of the flowchart(s) of FIGS. 6-7 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIGS. 6-7 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIGS. 6-7 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 16. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine readable instructions represented by the flowcharts of FIGS. 6-7 to perform first operation(s)/function(s), the FPGA circuitry 1600 of FIG. 16 may be configured and/or structured to perform second operation(s)/function(s) corresponding to a second portion of the machine readable instructions represented by the flowcharts of FIGS. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 3 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

A block diagram illustrating an example software distribution platform 1705 to distribute software such as the example machine readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions of FIGS. 6-7, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions of FIG. 6-7, may be downloaded to the example programmable circuitry platform 1400, which is to execute the machine readable instructions 1432 to implement the controller circuitry. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices. Although referred to as software above, the distributed “software” could alternatively be firmware.

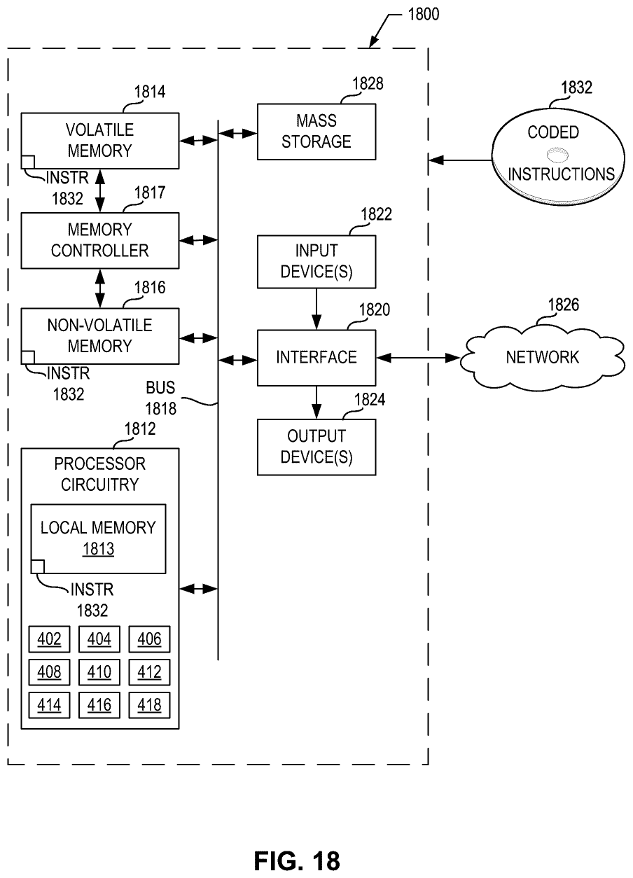

FIG. 18 is a block diagram of an example programmable circuitry platform 1800 structured to execute and/or instantiate the example machine-readable instructions and/or the example operations of FIGS. 8-13 to implement the server circuitry of FIG. 4. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs, microprocessors, CPUs, GPUs, DSPs, and/or microcontrollers from any desired family or manufacturer. The programmable circuitry 1812 may be implemented by one or more semiconductor based (e.g., silicon based) devices. In this example, the programmable circuitry 1812 implements the image processing circuitry 402, the image segmentation circuitry 404, the image conversion circuitry 406, the image correction circuitry 408, the cloud processing circuitry 410, the cloud classification circuitry 412, the cloud motion estimation circuitry 414, the solar irradiance modeling circuitry 416, and the post-processing circuitry 418.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store firmware, software, and/or data. Examples of such mass storage discs or devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1832, which may be implemented by the machine readable instructions of FIGS. 8-13, may be stored in the mass storage device 1828, in the volatile memory 1814, in the non-volatile memory 1816, and/or on at least one non-transitory computer readable storage medium such as a CD or DVD which may be removable.

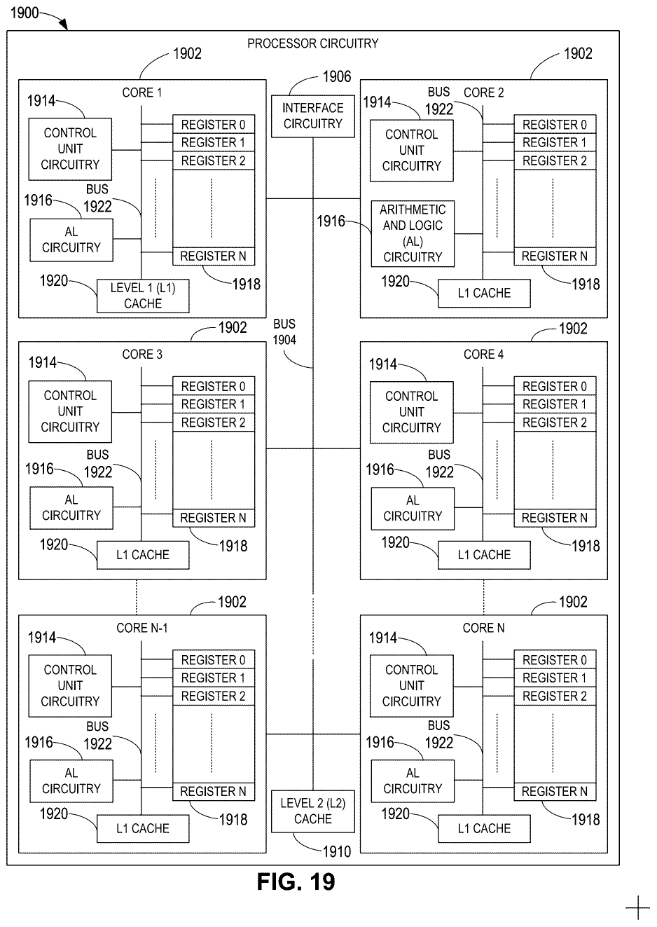

FIG. 19 is a block diagram of an example implementation of the programmable circuitry 1812 of FIG. 18. In this example, the programmable circuitry 1812 of FIG. 18 is implemented by a microprocessor 1900. For example, the microprocessor 1900 may be a general-purpose microprocessor (e.g., general-purpose microprocessor circuitry). The microprocessor 1900 executes some or all of the machine-readable instructions of the flowcharts of FIGS. 8-13 to effectively instantiate the circuitry of FIG. 4 as logic circuits to perform operations corresponding to those machine readable instructions. In some such examples, the circuitry of FIG. 4 is instantiated by the hardware circuits of the microprocessor 1900 in combination with the machine-readable instructions. For example, the microprocessor 1900 may be implemented by multi-core hardware circuitry such as a CPU, a DSP, a GPU, an XPU, etc. Although it may include any number of example cores 1602 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowcharts of FIGS. 8-13.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I²C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating-point operations. In yet other examples, the AL circuitry 1916 may include first AL circuitry that performs integer-based operations and second AL circuitry that performs floating-point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure, such as by being distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

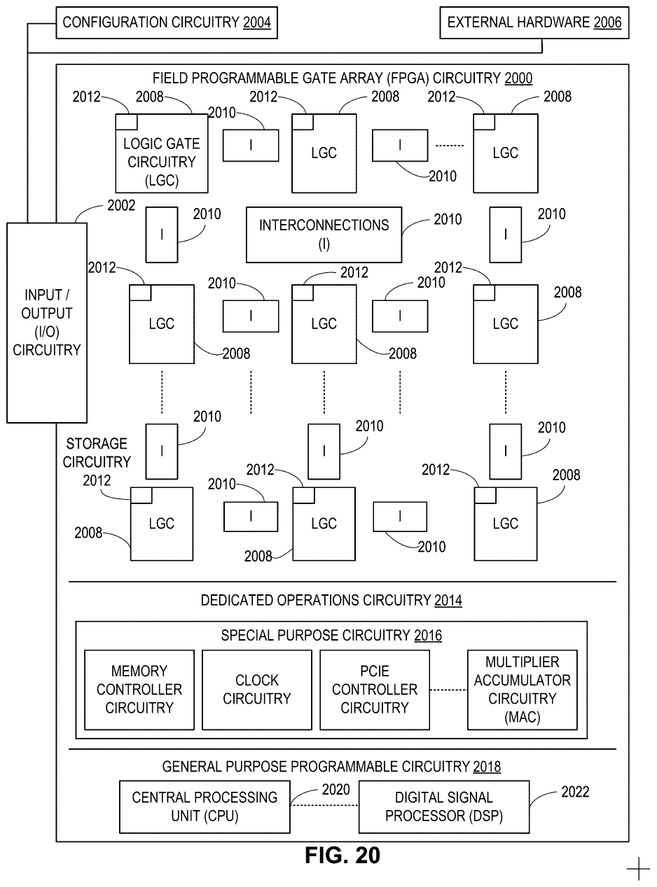

FIG. 20 is a block diagram of another example implementation of the programmable circuitry 1812 of FIG. 18. In this example, the programmable circuitry 1812 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine readable instructions. However, once configured, the FPGA circuitry 2000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1900 of FIG. 19 described above (which is a general purpose device that may be programmed to execute some or all of the machine readable instructions represented by the flowchart(s) of FIGS. 8-13 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8-13. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 8-13. As such, the FPGA circuitry 2000 may be configured and/or structured to effectively instantiate some or all of the operations/functions corresponding to the machine readable instructions of the flowcharts of FIGS. 8-13 as dedicated logic circuits to perform the operations/functions corresponding to those software instructions in a dedicated manner analogous to an ASIC. Therefore, the FPGA circuitry 2000 may perform the operations/functions corresponding to the some or all of the machine readable instructions of FIGS. 8-13 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine readable instructions of FIGS. 8-13 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1812 of FIG. 18, many other approaches are contemplated. For example, FPGA circuitry may include an on-board CPU, such as one or more of the example CPU 1920 of FIG. 19. Therefore, the programmable circuitry 1812 of FIG. 18 may additionally be implemented by combining at least the example microprocessor 1900 of FIG. 19 and the example FPGA circuitry 2000 of FIG. 20. In some such hybrid examples, one or more cores 1902 of FIG. 19 may execute a first portion of the machine readable instructions represented by the flowchart(s) of FIGS. 8-13 to perform first operation(s)/function(s), the FPGA circuitry 2000 of FIG. 20 may be configured and/or structured to perform second operation(s)/function(s) corresponding to a second portion of the machine readable instructions represented by the flowcharts of FIGS. 8-13, and/or an ASIC may be configured and/or structured to perform third operation(s)/function(s) corresponding to a third portion of the machine readable instructions represented by the flowcharts of FIGS. 8-13.

It should be understood that some or all of the circuitry of FIG. 4 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIG. 18 may be instantiated, for example, in one or more threads executing concurrently and/or in series. For example, the microprocessor 1900 of FIG. 19 may execute machine readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIG. 4 may be implemented within one or more virtual machines and/or containers executing on the microprocessor 1900 of FIG. 19.

In some examples, the programmable circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1812 of FIG. 18, which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

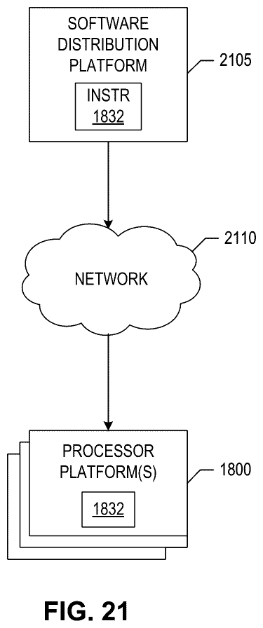

A block diagram illustrating an example software distribution platform 2105 to distribute software such as the example machine readable instructions 1832 of FIG. 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine readable instructions 1832, which may correspond to the example machine readable instructions of FIGS. 8-13, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1832 from the software distribution platform 2105. For example, the software, which may correspond to the example machine readable instructions of FIG. 8-13, may be downloaded to the example programmable circuitry platform 1800, which is to execute the machine readable instructions 1832 to implement the server circuitry 108. In some examples, one or more servers of the software distribution platform 2105 periodically offer, transmit, and/or force updates to the software (e.g., the example machine readable instructions 1832 of FIG. 18) to ensure improvements, patches, updates, etc., are distributed and applied to the software at the end user devices. Although referred to as software above, the distributed “software” could alternatively be firmware. Further, the solar irradiance model can be distributed to an end user, a market, and/or any other operator for the generation of predictions of solar irradiance.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that determine a solar irradiance model. Disclosed systems, apparatus, articles of manufacture, and methods improve the efficiency of using a computing device by ensuring accurate modeling of solar irradiance despite fluctuations in cloud cover. Additionally, based on the generated solar irradiance model and predictions of solar irradiance using the solar irradiance model, configurations of power and allocations of power can be adjusted to account for fluctuations in solar irradiance. Accordingly, fluctuations of solar power can be predicted using the disclosed solar irradiance model to stabilize power supply and power markets. Accordingly, unlike previous systems where power markets are left unpredicted and unstable due to a lack of information and/or inaccurate information regarding solar power, power fluctuations can be predicted and accounted for. Disclosed systems, apparatus, articles of manufacture, and methods are accordingly directed to one or more improvement(s) in the operation of a machine such as a computer or other electronic and/or mechanical device.

In particular, predictions of solar irradiance and the generation of a solar irradiance model can enable accurate determinations of the availability of future solar power. Therefore, when less solar power is available due to weather conditions, solar farms can meter dispersal of power prior to and during a solar irradiance event to enable consistent power delivery. Further, market analysis and hedging decisions can be based on the prediction of solar irradiance to reduce unexpected energy expenditures.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to predict solar irradiance, the apparatus comprising:
interface circuitry;
machine-readable instructions; and
at least one processor circuit to be programmed by the machine-readable instructions to:
perform image processing of an image received from a collection device;
determine a characteristic of a cloud in the image;
determine a prediction of solar irradiance based on a solar irradiance model, the prediction determined based on the characteristic; and
output the prediction to a client device.

2. The apparatus of claim 1, wherein one or more of the at least one processor circuit, to perform the image processing, is to:
segment the image based on distance from a sun;
convert a color scale of the image; and
apply a correction filter to the image.

3. The apparatus of claim 2, wherein the image is segmented into three regions: a first region, a second region, and a third region, wherein the first region is closest to the sun and the third region is farthest from the sun.

4. The apparatus of claim 2, wherein one or more of the at least one processor circuit, to determine the characteristic of the cloud in the image, is to:
detect the cloud in the image;
classify the detected cloud; and
estimate motion of the detected cloud.

5. The apparatus of claim 4, wherein the at least one processor circuit is to detect the cloud in the image using at least one of a machine learning model or an image thresholding to determine whether the cloud is located in a pixel of the image.

6. The apparatus of claim 4, wherein the at least one processor circuit is to classify the detected cloud based on at least one of type or height.

7. The apparatus of claim 4, wherein the at least one processor circuit is to estimate motion of the detected cloud based on at least one of optical flow or maximum cross-correlation.

8. The apparatus of claim 4, wherein the at least one processor circuit is to use machine learning to classify cloud characteristics, including cloud type and height, to enhance solar irradiance modeling.

9. The apparatus of claim 2, wherein one or more of the at least one processor circuit, to determine the solar irradiance model of the image based on a luminance value extracted from the image, a solar zenith angle of the image, and an atmospheric transmittance of the image.

10. At least one non-transitory machine-readable medium comprising machine-readable instructions to cause at least one processor circuit to at least:
perform image processing of an image received from a collection device;
determine a characteristic of a cloud in the image;
determine a prediction of solar irradiance based on a solar irradiance model, the prediction determined based on the determined characteristic; and
output the prediction.

11. The at least one non-transitory machine-readable medium of claim 10, wherein the machine-readable instructions are to cause one or more of the at least one processor circuit to:
segment the image based on distance from a sun;
convert a color scale of the image; and
apply a correction filter to the image.

12. The at least one non-transitory machine-readable medium of claim 11, wherein the image is segmented into three regions: a first region, a second region, and a third region, wherein the first region is closest to the sun and the third region is farthest from the sun.

13. The at least one non-transitory machine-readable medium of claim 10, wherein the machine-readable instructions are to cause one or more of the at least one processor circuit, to determine the characteristic of the cloud in the image, to:
detect the cloud in the image;
classify the detected cloud; and
estimate motion of the detected cloud.

14. The at least one non-transitory machine-readable medium of claim 13, wherein the at least one processor circuit is to detect the cloud in the image using at least one of a machine learning model or an image thresholding to determine whether the cloud is located in a pixel of the image.

15. The at least one non-transitory machine-readable medium of claim 13, wherein the at least one processor circuit is to classify the detected cloud based on at least one of type or height.

16. The at least one non-transitory machine-readable medium of claim 13, wherein the at least one processor circuit is to estimate motion of the detected cloud based on at least one of optical flow or maximum cross-correlation.

17. The at least one non-transitory machine-readable medium of claim 10, wherein the machine-readable instructions are to cause one or more of the at least one processor circuit to determine the solar irradiance model of the image based on a luminance value extracted from the image, a solar zenith angle of the image, and an atmospheric transmittance of the image.

18. A method comprising:
performing image processing of an image received from a collection device;
determining a characteristic of a cloud in the image;
determining, by at least one processor circuit programmed by at least one instruction, a prediction of solar irradiance based on a solar irradiance model, the prediction determined based on the determined characteristic; and
outputting the prediction.

19. The method of claim 18, wherein performing the image processing further includes:
segmenting the image based on distance from a sun;
converting a color scale of the image; and
applying a correction filter to the image.

20. The method of claim 19, wherein the image is segmented into three regions: a first region, a second region, and a third region, wherein the first region is closest to the sun and the third region is farthest from the sun.
